(19) United States
(12) Patent Application Publication
(10) Pub. No.: US 2025/0168840 A1
(43) Pub. Date: May 22, 2025

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Yang MING, Beijing (CN); Zhaocheng WANG, Beijing (CN); Jianfei CAO, Beijing (CN)

(73) Assignee: Sony Group Corporation, Tokyo (JP)

(21) Appl. No.: 18/840,186

(22) PCT Filed: Mar. 22, 2023
(86) PCT No.: PCT/CN2023/082942

§ 371 Date: Aug. 21, 2024

(30) Foreign Application Priority Data
Mar. 29, 2022 (CN) 202210317437.2

(51) Int. Cl. H04W 72/044; H04L 5/00; H04W 72/541; H04W 72/542

(52) U.S. Cl. CPC H04W 72/0473; H04L 5/0057; H04W 72/541; H04W 72/542

(57) ABSTRACT

The present disclosure provides an electronic device for wireless communication, comprising a processing circuit configured to set, according to report information of the channel quality between a user equipment and the electronic device and between the user equipment and a neighboring electronic device adjacent to the electronic device reported by the user equipment within the service range thereof, the following indication information comprised in information corresponding to a resource block in relative narrowband transmission power (RNTP) signaling to be sent to neighboring electronic devices, wherein the indication information is used for indicating the degree that the user equipment of the electronic device scheduled on the resource block is interfered by the neighboring electronic device.

This application claims priority to Chinese Patent Application No. 202210317437.2 titled “ELECTRONIC DEVICE AND METHOD FOR WIRELESS COMMUNICATION, AND COMPUTER READABLE STORAGE MEDIUM”, filed on Mar. 29, 2022 with the China National Intellectual Property Administration (CNIPA), which is incorporated herein by reference in its entirety.

### FIELD

The present disclosure relates to the technical field of wireless communications, and in particular to an electronic apparatus and method for wireless communications and a computer-readable storage medium. More specifically, the present disclosure involves improvements to conventional relative narrowband transmit power (RNTP) signaling.

### BACKGROUND

In a downlink, when two neighboring cells simultaneously schedule a cell edge user on a same resource block (RB), the cell edge user is likely to be subject to strong inter-cell interference (ICI), which affects a performance of the cell edge user. Therefore, Inter-cell Interference Coordination (ICIC) is introduced in the LTE standard in order to avoid occurrence of strong ICI. RNTP signaling is utilized to perform downlink ICIC. According to existing standards, the RNTP signaling indicates merely whether a transmit power of a cell base station on a given resource block exceeds a predetermined threshold.

In addition, in a distributed multiple-input multiple-output (D-MIMO) downlink scenario, multiple antennas for serving cells are distributed on remote radio heads (RRHs) at different geographic locations. Each of the RRHs may be equipped with multiple antennas, and the antennas are all connected to a same baseband processing unit (BBU) via a forward-transmission link and serve a same cell. Processing of transmitting signals and receiving signals are all transmitted from the RRH to the BBU, and then centrally processed by the BBU. The RNTP signaling is utilized in the D-MIMO system for the downlink ICIC.

### SUMMARY

A brief summary of the present disclosure is given below, to provide a basic understanding of some aspects of the present disclosure. It should be understood that the following summary is not an exhaustive summary of the present disclosure. It does not intend to determine a key or important part of the present disclosure, nor does it intend to limit the scope of the present disclosure. Its objective is merely to present some concepts in a simplified form, which serves as a preamble of a more detailed description to be discussed later.

According to an aspect of the present disclosure, an electronic apparatus for wireless communications is provided. The electronic apparatus includes processing circuitry, configured to: set, in relative narrowband transmit power RNTP signaling to be sent to a neighboring electronic apparatus in proximity to the electronic apparatus, following indication information included in information corresponding to a resource block according to report information that is reported by user equipment within a service range of the electronic apparatus and that is based on channel quality between the user equipment and the electronic apparatus and channel quality between the user equipment and the neighboring electronic apparatus, where the indication information is utilized to indicate a degree to which the user equipment scheduled by the electronic apparatus on the resource block is interfered by the neighboring electronic apparatus.

In an embodiment according to the present disclosure, the electronic apparatus indicates, in the RNTP signaling to be sent to the neighboring electronic apparatus, the degree to which the user equipment scheduled on the resource block is interfered by the neighboring electronic apparatus based on the report information about channel quality reported by the user equipment. Therefore, an interference condition can be correctly reflected, and thereby a communication performance can be improved.

According to an aspect of the present disclosure, an electronic apparatus for wireless communications is provided. The electronic apparatus includes processing circuitry, configured to: perform scheduling based on RNTP signaling received from a neighboring electronic apparatus in proximity to the electronic apparatus, where the neighboring electronic apparatus sets, in the RNTP signaling, following indication information included in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, where the indication information is utilized to indicate a degree to which the user equipment scheduled by the neighboring electronic apparatus on the resource block is interfered by the electronic apparatus.

In an embodiment according to the present disclosure, based on the indication information that is included in the received RNTP signaling and that indicates the degree to which the user equipment scheduled by the neighboring electronic apparatus on the resource block is interfered by the electronic apparatus, the electronic apparatus can determine an interference condition correctly during the scheduling. Hence, the communication performance can be improved.

According to an aspect of the present disclosure, an electronic apparatus for wireless communications is provided. The electronic apparatus includes processing circuitry, configured to: report, to a network-side apparatus that provides services for the electronic apparatus, report information that is based on channel quality between the electronic apparatus and the network-side apparatus and channel quality between the electronic apparatus and a neighboring network-side apparatus in proximity to the network-side apparatus, for the network-side apparatus to set following indication information included in information corresponding to a resource block in relative narrowband transmit power RNTP signaling to be sent to the neighboring network-side apparatus, where the indication information is utilized to indicate a degree to which the electronic apparatus scheduled by the network-side apparatus on the resource block is interfered by the neighboring network-side apparatus.

In an embodiment according to the present disclosure, the electronic apparatus reports the report information about channel quality to the network-side apparatus, so that the network-side apparatus indicates, in the RNTP signaling to be sent to the neighboring electronic apparatus, the degree to which the electronic apparatus scheduled on the resource block is interfered by the neighboring electronic apparatus. Therefore, an interference condition can be correctly reflected, and thereby a communication performance can be improved.

According to an aspect of the present disclosure, an electronic apparatus for wireless communications is provided. The electronic apparatus includes processing circuitry, configured to: set following power information included in information corresponding to a resource block in RNTP signaling to be sent to a neighboring electronic apparatus in proximity to the electronic apparatus, where the power information is utilized to indicate, for each of a plurality of remote radio head (RRHs) in a cell to which the electronic apparatus belongs, whether the RRH schedules user equipment on the resource block at a transmit power higher than a fourth predetermined threshold.

In an embodiment according to the present disclosure, an electronic apparatus reflects, in the RNTP signaling, condition of the transmit power about different RRHs. Hence, different degrees of interference caused by different RRHs to the cell to which the neighboring electronic apparatus belongs can be reflected correctly, and thereby the communication performance is improved.

According to an aspect of the present disclosure, an electronic apparatus for wireless communications is provided. The electronic apparatus includes processing circuitry, configured to: perform scheduling based on RNTP signaling received from a neighboring electronic apparatus in proximity to the electronic apparatus, where the neighboring electronic apparatus sets following power information included in information corresponding to a resource block in the RNTP signaling, the power information is utilized to indicate, for each of a plurality of RRHs in a cell to which the neighboring electronic apparatus belongs, whether the RRH schedules user equipment on the resource block at a transmit power higher than a fourth predetermined threshold, and a cell to which the electronic apparatus belongs includes a plurality of RRHs.

In an embodiment according to the present disclosure, based on the power information that is included in the received RNTP signaling and that indicates a condition of the transmit power of different RRHs in the neighboring electronic apparatus, the electronic apparatus can determine interference conditions of different RRHs in the neighboring electronic apparatus correctly during the scheduling. Hence, the communication performance can be improved.

According to an aspect of the present disclosure, a method for wireless communications is provided. The method includes: setting, in RNTP signaling to be sent to a neighboring electronic apparatus in proximity to an electronic apparatus, following indication information included in information corresponding to a resource block according to report information that is reported by user equipment within a service range of the electronic apparatus and that is based on channel quality between the user equipment and the electronic apparatus and channel quality between the user equipment and the neighboring electronic apparatus, where the indication information is utilized to indicate a degree to which the user equipment scheduled by the electronic apparatus on the resource block is interfered by the neighboring electronic apparatus.

According to an aspect of the present disclosure, a method for wireless communications is provided. The method includes: performing scheduling based on RNTP signaling received from a neighboring electronic apparatus in proximity to an electronic apparatus, where the neighboring electronic apparatus sets, in the RNTP signaling, following indication information included in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, where the indication information is utilized to indicate a degree to which the user equipment scheduled by the neighboring electronic apparatus on the resource block is interfered by the electronic apparatus.

According to an aspect of the present disclosure, a method for wireless communications is provided. The method includes: reporting, to a network-side apparatus that provides services for an electronic apparatus, report information that is based on channel quality between the electronic apparatus and the network-side apparatus and channel quality between the electronic apparatus and a neighboring network-side apparatus in proximity to the network-side apparatus, for the network-side apparatus to set following indication information included in information corresponding to a resource block in RNTP signaling to be sent to the neighboring network-side apparatus, where the indication information is utilized to indicate a degree to which the electronic apparatus scheduled by the network-side apparatus on the resource block is interfered by the neighboring network-side apparatus.

According to an aspect of the present disclosure, a method for wireless communications is provided. The method includes: setting following power information included in information corresponding to a resource block in RNTP signaling to be sent to a neighboring electronic apparatus in proximity to an electronic apparatus, where the power information is utilized to indicate, for each of a plurality of RRHs in a cell to which the electronic apparatus belongs, whether the RRH schedules user equipment on the resource block at a transmit power higher than a fourth predetermined threshold.

According to an aspect of the present disclosure, a method for wireless communications is provided. The method includes: performing scheduling based on RNTP signaling received from a neighboring electronic apparatus in proximity to an electronic apparatus, where the neighboring electronic apparatus sets following power information included in information corresponding to a resource block in the RNTP signaling, the power information is utilized to indicate, for each of a plurality of RRHs in a cell to which the neighboring electronic apparatus belongs, whether the RRH schedules user equipment on the resource block at a transmit power higher than a fourth predetermined threshold, and a cell to which the electronic apparatus belongs includes multiple RRHs.

According to other aspects of the present disclosure, there are further provided a computer program code and a computer program product for implementing the above-described methods for wireless communications, and a computer-readable storage medium having the computer program code for implementing the methods for wireless communications recorded thereon.

These and other advantages of the present disclosure become more apparent through preferred embodiments of the present disclosure described in detail below in conjunction with accompany drawings.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for wireless communications according to an embodiment of the present disclosure;

FIG. 2 is a diagram illustrating an example of a wireless communication system utilizing conventional RNTP signaling;

FIG. 3 is a diagram illustrating another example of a wireless communication system utilizing conventional RNTP signaling in according to conventional technology;

FIG. 4 is an example illustrating signaling interactions between an electronic apparatus, a neighboring electronic apparatus, and user equipment according to an embodiment of the present disclosure;

FIG. 5 is an example illustrating a D-MIMO system;

FIG. 6 shows a block diagram of functional modules of an electronic apparatus for wireless communications according to another embodiment of the present disclosure;

FIG. 7 illustrates an example of an electronic apparatus applying enhanced RNTP signaling for scheduling according to an embodiment of the present disclosure;

FIG. 8 illustrates an example of a simulation of a conventional cellular network scenario in which enhanced RNTP signaling according to an embodiment of the present disclosure is applied;

FIG. 9 illustrates a plot of a cumulative distribution function of an average user reachable rate obtained by applying enhanced RNTP signaling versus applying conventional RNTP signaling in a conventional cellular network scenario;

FIG. 10 illustrates an example of application of enhanced RNTP signaling in a multi-antenna highly directional beam scenario according to an embodiment of the present disclosure;

FIG. 11 illustrates an example application of enhanced RNTP signaling in a D-MIMO scenario according to an embodiment of the present disclosure;

FIG. 12 illustrates an example of a simulation of a D-MIMO scenario in which enhanced RNTP signaling according to an embodiment of the present disclosure is applied;

FIG. 13 illustrates a plot of a cumulative distribution function of an average user reachable rate obtained by applying enhanced RNTP signaling versus applying conventional RNTP signaling in a D-MIMO scenario;

FIG. 14 shows a block diagram of functional modules of an electronic apparatus for wireless communications according to a further embodiment of the present disclosure;

FIG. 15 shows a block diagram of functional modules of an electronic apparatus for wireless communications according to a further embodiment of the present disclosure;

FIG. 16 shows a block diagram of functional modules of an electronic apparatus for wireless communications according to a further embodiment of the present disclosure;

FIG. 17 illustrates an example of scheduling based on D-MIMO enhanced RNTP signaling for an electronic apparatus according to an embodiment of the present disclosure;

FIG. 18 illustrates a plot of a cumulative distribution function of an average user reachable rate obtained by applying D-MIMO enhanced RNTP signaling versus applying conventional RNTP signaling in a D-MIMO scenario;

FIG. 19 shows a flow chart of a method for wireless communications according to an embodiment of the present disclosure;

FIG. 20 shows a flow chart of a method for wireless communications according to another embodiment of the present disclosure;

FIG. 21 shows a flow chart of a method for wireless communications according to a further embodiment of the present disclosure;

FIG. 22 shows a flow chart of a method for wireless communications according to a further embodiment of the present disclosure;

FIG. 23 shows a flow chart of a method for wireless communications according to a further embodiment of the present disclosure;

FIG. 24 is a block diagram showing a first example of a schematic configuration of an eNB or gNB to which the technology of the present disclosure can be applied;

FIG. 25 is a block diagram showing a second example of a schematic configuration of an eNB or gNB to which the technology of the present disclosure can be applied;

FIG. 26 is a block diagram showing an example of a schematic configuration of a smart phone to which the technology of the present disclosure can be applied;

FIG. 27 is a block diagram showing an example of a schematic configuration of automobile navigation device to which the technology of the present disclosure can be applied; and

FIG. 28 is a block diagram of an exemplary structure of a universal personal computer in which the methods and/or apparatuses and/or systems according to the embodiments of the present invention can be implemented.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made during developing any of such actual implementations so as to achieve specific objectives of a developer, for example, to comply with system- and business-related constraining conditions which will vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

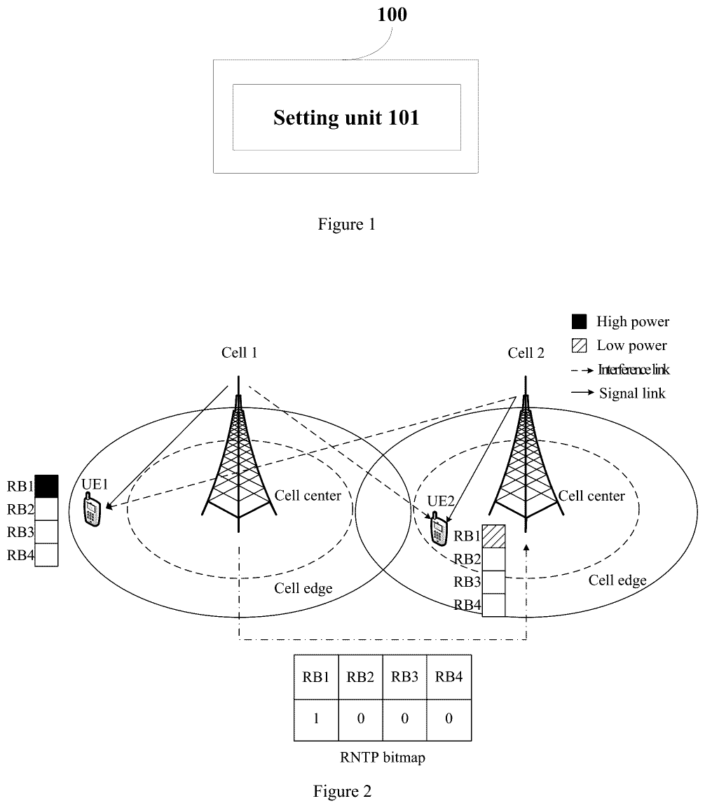

FIG. 1 shows a block diagram of functional modules of an electronic apparatus 100 for wireless communications according to an embodiment of the present disclosure.

As shown in FIG. 1, the electronic apparatus 100 includes a setting unit 101. The setting unit 101 may be configured to: set, in RNTP signaling to be sent to a neighboring electronic apparatus in proximity to the electronic apparatus 100, following indication information included in information corresponding to a resource block according to report information that is reported by user equipment within a service range of the electronic apparatus 100 and that is based on channel quality between the user equipment and the electronic apparatus 100 and channel quality between the user equipment and the neighboring electronic apparatus, where the indication information is utilized to indicate a degree to which the user equipment scheduled by the electronic apparatus 100 on the resource block is interfered by the neighboring electronic apparatus.

The setting unit 101 may be implemented by one or more processing circuits. The processing circuitry may be implemented as a chip, for example.

The electronic apparatus 100 may serve as a network-side apparatus in a wireless communication system, and may be specifically provided on a base station side or be communicatively connected to the base station, for example. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here.

The base station may be an eNB or gNB, as an example.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art can understand that the wireless communication system according to the present disclosure may be a 4G or 3G communication system.

For example, the resource block may be a time domain resource block and/or a frequency domain resource block.

Hereinafter, user equipment scheduled by the electronic apparatus 100 on the resource block is sometimes referred to as user equipment device UEa, for simplicity. Description is made by way of an example in which the electronic apparatus 100 and a neighboring electronic apparatus are implemented as base stations.

Different base stations may cause different degrees of interference to the user equipment UEa. A degree to which the user equipment UEa is interfered by the neighboring electronic apparatus may be reflected, to some extent, by channel quality between the user equipment UEa and the electronic apparatus 100 and channel quality between the user equipment UEa and a neighboring electronic apparatus.

In the conventional technology, each bit, in a bitmap included in RNTP signaling sent by a Cell 1 base station, corresponds to an RB for informing a neighboring Cell 2 base station whether the Cell 1 base station plans to keep a transmit power corresponding to the RB lower than a predetermined threshold. A “O” for this bit indicates that the Cell 1 base station plans to keep the transmit power corresponding to the RB lower than the predetermined threshold; and otherwise, indicates that the transmit power of the Cell 1 base station on the RB exceeds the predetermined threshold. The predetermined threshold and a limited time period indicated by the RNTP signaling are configurable. Hence, the neighboring Cell 2 base station, when scheduling its UE, may consider a signal transmit power of the Cell 1 base station on each RB. The neighboring Cell 2 base station, on reception of a high power indication of Cell 1 RNTP signaling on certain RBs, typically avoids scheduling UE at an edge of Cell 2 on the RBs, and generally schedules and serves UE with a low power in order to avoid strong ICI to the Cell 1.

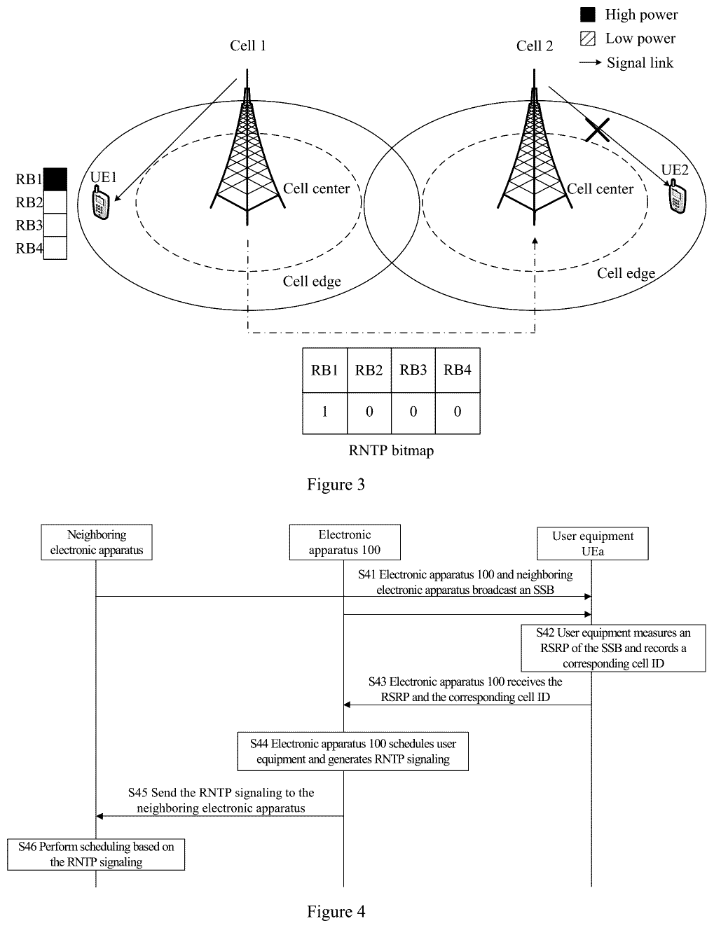

Actual use of RNTP signaling in a downlink ICIC under a current LTE standard is illustrated below in conjunction of FIG. 2 and FIG. 3. FIG. 2 is a diagram illustrating an example of a wireless communication system utilizing conventional RNTP signaling. As shown in FIG. 2, Cell 1 base station schedules UE1 on RB1 and serves UE1 at a high power. Therefore, in a bitmap included in RNTP signaling sent to Cell 2 base station, the RB1 corresponds to a bit “1”, and each of RB2 to RB4 corresponds to a bit “0”. After the Cell 2 base station receives the RNTP signaling sent from the Cell 1 base station (which indicates a high transmit power of the Cell 1 base station on the RB1), the Cell 2 base station typically schedules a cell-centric user in Cell 2 (for example, UE2 in FIG. 2) on the RB1 and serves the UE2 at a low power, so as to mitigate ICI. However, since the UE2 is close to the edge of the Cell 2, the UE2 may have a poor service quality because of high interference from the Cell 1 base station and a low power at which the UE2 is served. However, in practice, due to a large distance between the UE1 and the Cell 2 base station, a fact that the Cell 2 serves the UE2 with a high power actually has less impact on the quality of service of the UE1 in the Cell 1. FIG. 3 is a diagram illustrating another example of a wireless communication system utilizing conventional RNTP signaling in according to conventional technology. As shown in FIG. 3, in a bitmap included in RNTP signaling, RB1 corresponds to a bit “1”, and each of RB2 to RB4 corresponds to a bit “0”. Typically, when Cell 1 schedules UE1 on RB1 at a high power, Cell 2 cannot schedule cell edge user UE2 on the RB1 due to a constraint indicated in the RNTP signaling. However, in practice, since UE1 is far away from the Cell 2 base station, a fact that the Cell 2 serves the cell edge user UE2 on the RB1 at a high power has less impact on the quality of service of the UE1. Meanwhile, since the Cell 2 edge user UE2 is far away from a base station of Cell 1, the quality of service of the UE2 is ensured. From FIG. 2 and FIG. 3, it can be seen that a degree to UE in a cell cannot be correctly indicated through only a transmit power in conventional RNTP signaling, which may easily lead to a neighboring cell to misjudge an interference condition, and thus degrades a communication performance.

In contrast, in an embodiment according to the present disclosure, the above-mentioned indication information (e.g., one bit) is added, with respect to each RB, to the bitmap included in the RNTP signaling, to indicate a degree to which UEa scheduled on a certain RB is interfered by a neighboring electronic apparatus that receives the RNTP signaling. Thereby, a detailed indication of the interference condition is allowed. Specifically, a bit value “0” added on a certain RB indicates a low degree to which the UE scheduled on the RB is interfered by a neighboring electronic apparatus. A bit value “1” added on a certain RB indicates a high degree to which the UEa scheduled on the RB is interfered by a neighboring electronic apparatus.

In summary, in the embodiment according to the present disclosure, the electronic apparatus 100 indicates, in the RNTP signaling to be sent to the neighboring electronic apparatus, the degree to which the user equipment UEa scheduled on the resource block is interfered by the neighboring electronic apparatus based on the report information about channel quality reported by the user equipment UEa. Therefore, an interference condition can be correctly reflected, so that the neighboring electronic apparatus may consider the interference condition during the scheduling, for example, and thereby a communication performance can be improved.

In an embodiment of the present disclosure, each RB in the bitmap included in the RNTP signaling corresponds to four combinations of bits. The four combinations and their meanings are shown in Table 1. (Hereinafter, a bit indicating a transmit power on an RB in conventional RNTP signaling is sometimes referred to as an original bit; and a bit added to RNTP signaling, according to an embodiment of the present disclosure, for indicating a degree to which a UE scheduled by the electronic apparatus 100 on the RB is interfered by a neighboring electronic apparatus (where the bit is an example of indication information), is referred to as an additional bit).

TABLE 1

| Original bit | Additional bit | Explanation |
|---|---|---|
| 1 | 1 | High transmit power on RB; and high degree to which UE |
| | | scheduled on a corresponding RB is interfered by a |
| | | neighboring electronic apparatus |
| 1 | 0 | High transmit power on RB; and low degree to which UE |
| | | scheduled on a corresponding RB is interfered by a |
| | | neighboring electronic apparatus |
| 0 | 1 | Low transmit power on RB; and high degree to which UE |
| | | scheduled on a corresponding RB is interfered by a |
| | | neighboring electronic apparatus |
| 0 | 0 | Low transmit power on RB; and low degree to which UE |
| | | scheduled on a corresponding RB is interfered by a |
| | | neighboring electronic apparatus |

For example, it should be noted that the third case listed in the table (in which the original bit is 0 and the additional bit is 1) does not occur generally, and may be used in a case where the number of base station antennas is particularly large and a directional beam is particularly pronounced.

As can be seen from Table 1, in RNTP signaling according to an embodiment of the present disclosure, information corresponding to each RB includes the original bit and the additional bit as described above.

As an example, the neighboring electronic apparatus is capable of communicating with the electronic apparatus 100 through an X2 interface. For example, the electronic apparatus 100 sends RNTP signaling to the neighboring electronic apparatus through the X2 interface.

As an example, the degree of interference is determined by using a ratio of channel quality corresponding to the electronic apparatus 100 to channel quality corresponding to the neighboring electronic apparatus.

For example, assuming existence of N (N is a positive integer greater than or equal to 1) neighboring electronic apparatuses, the ratio «¿ of channel quality corresponding to electronic apparatus 100 to channel quality corresponding to the neighboring electronic apparatus device i (i=1, 2, . . . , N) may be expressed as:

$${α}_{i} = \frac{{CQ}_{s}}{{CQ}_{i}} \qquad ( 1 )$$

In the equation, CQₛ represents channel quality between user equipment UEa and the electronic apparatus 100, and CQᵢ represents channel quality between the user equipment UEa and the neighboring electronic apparatus i.

As an example, the report information includes a cell ID of a cell to which the electronic apparatus 100 belongs and a cell ID of a cell to which the neighboring electronic apparatus belongs. That is, the user equipment UEa reports, to the electronic apparatus 100, the channel quality between the user equipment UEa and the electronic apparatus 100 and the cell ID of the cell to which the electronic apparatus 100 belongs, and the channel quality between the user equipment UEa and the neighboring electronic apparatus and the cell ID of the cell to which the neighboring electronic apparatus belongs.

As an example, the channel quality includes a reference signal received power RSRP or a signal to interference and noise ratio SINR of a reference signal. Those skilled in the art may envisage other indications of the channel quality, which are not described here. In the following, the channel quality is sometimes described as RSRP as an example, for convenience. As an example, the reference signal may be one of the following: a synchronization signal block (SSB), a demodulation reference signal (DMRS), a channel state information reference signal (CSI-RS), and the like. In the following, the reference signal is sometimes described as SSB as an example, for convenience.

As an example, the setting unit 101 may be configured to: calculate the ratio based on the channel quality corresponding to the electronic apparatus 100 and the channel quality corresponding to the neighboring electronic apparatus included in the report information; perform the determination based on a comparison of the ratio to a first predetermined threshold; and set the indication information based on a result of the determination.

In addition to the determination based on a comparison of the ratio to the first predetermined threshold, other ways of determining the degree of interference based on the ratio may be envisaged by those skilled in the art and are not described in detail here.

For example, a base station in a cell broadcasts an SSB with a cell ID, and therefore the user equipment UEa may measure an RSRP of the SSB and differentiate RSRPs of SSBs from different cells based on cell IDs. The user equipment UEa then reports, to the electronic apparatus 100, a received signal power of an SSB of each cell and a corresponding cell ID. Further, in a case where the measured received signal power of the SSB of a cell is too small, it is indicated that the cell does not cause high interference to the user equipment UEa. Therefore, in order to reduce a reporting overhead, the user equipment UEa may choose to report only an RSRP whose value is greater than a specific threshold and a cell ID corresponding to the RSRP.

After the electronic apparatus 100 receives a report from the user equipment UEa, the electronic apparatus 100 calculates a ratio at based on the RSRP and the cell ID corresponding to the RSRP reported from the user equipment UEa.

For example, in a case where the ratio αᵢ is greater than a first predetermined threshold, which indicates that a received signal power of an SSB corresponding to the electronic apparatus 100 is higher than a received signal power of an SSB corresponding to the neighboring electronic apparatus i, it is determined that the degree to which the user equipment UEa is interfered by the neighboring electronic apparatus i is low. In a case where the ratio αᵢ is less than or equal to the first predetermined threshold, which indicates that the received signal power of the SSB corresponding to the electronic apparatus 100 is lower than the received signal power of the SSB corresponding to the neighboring electronic apparatus i, it is determined that the degree to which the user equipment UEa is interfered by the neighboring electronic apparatus i is high.

For example, the electronic apparatus 100 sets the indication information in the RNTP signaling to 0 in a case where it is determined that the degree to which the user equipment UEa is interfered by a neighboring electronic apparatus i is low, and sets the indication information in the RNTP signaling to 1 in a case where it is determined that the degree to which the user equipment UEa is interfered by the neighboring electronic apparatus i is high.

The RNTP signaling according to an embodiment of the present disclosure may describe the impact of different base stations on the user equipment UEa, and the user equipment UEa measures the channel quality between the user equipment and each of different base stations. Since the ratio may vary for different neighboring electronic apparatuses, there may be different bitmaps included in the RNTP signaling sent by the electronic apparatus 100 to different neighboring electronic apparatuses.

For example, those skilled in the art may predetermine the first predetermined threshold based on experience, application scenarios, experiments, and the like.

As an example, the setting unit 101 may be configured to: perform the determination based on a comparison of a first predetermined threshold to the ratio calculated by the user equipment and included in the report information, and set the indication information based on a result of the determination.

Since calculation of αᵢ does not require a large amount of computation, the user equipment UEa may calculate αᵢ and then report αᵢ and a corresponding cell ID to the electronic apparatus 100. In a case where the ratio αᵢ is greater than the first predetermined threshold, the electronic apparatus 100 determines that the degree to which the user equipment UEa is interfered by a neighboring electronic apparatus i is low, and sets the indication information in the RNTP signaling to 0. In a case where the ratio at is less than or equal to the first predetermined threshold, the electronic apparatus 100 determines that the degree to which the user equipment UEa is interfered by the neighboring electronic apparatus i is high, and sets the indication information in the RNTP signaling to 1.

As an example, the report information includes initial information indicating the degree of interference, where the initial information is obtained by the user equipment based on a comparison of the ratio to a first predetermined threshold, and the setting unit 101 may be configured to set the indication information based on the initial information.

For example, the user equipment UEa calculates the di. In a case where the ratio di is greater than the first predetermined threshold, the user equipment UEa determines that the degree to which the user equipment UEa is interfered by a neighboring electronic apparatus i is low, and sets the initial information to 0. In a case where the ratio at is less than or equal to the first predetermined threshold, the user equipment UEa determines that the degree to which the user equipment UEa is interfered by the neighboring electronic apparatus i is high, and sets the initial information to 1. That is, since calculation of αᵢ does not require a large amount of computation, the user equipment UEa may calculate the αᵢ and obtain a bitmap based on the at, where the bitmap reflects a degree to which the user equipment UEa is interfered by the neighboring electronic apparatus. Each bit (initial information) in the bitmap corresponds to a neighboring electronic apparatus i. The bit indicates the degree to which the user equipment UEa is interfered by the neighboring electronic apparatus i. The user equipment UEa reports the bitmap and a corresponding cell ID to the electronic apparatus 100, so that the reporting overhead can be further reduced.

For example, the electronic apparatus 100 sets the indication information to be the same as the initial information.

Hereinafter, the neighboring electronic apparatus i is referred to as a neighboring electronic apparatus, and the neighboring electronic apparatus is sometimes referred to as a neighboring electronic apparatus Eq, for simplicity.

As an example, the setting unit 101 may be configured to set the indication information further based on beam information indicating whether the user equipment is within a range of a directional beam of the neighboring electronic apparatus.

In a case where the user equipment UEa is within a range of a directional beam of the neighboring electronic apparatus, the indication information is set based on the beam information, so that a degree of interference on the user equipment UEa can be reflected more accurately. Hence, the neighboring electronic apparatus may consider the degree of interference during the scheduling, for example, and thereby the communication performance is further improved.

FIG. 4 is an example illustrating signaling interactions between an electronic apparatus 100, a neighboring electronic apparatus, and user equipment UEa according to an embodiment of the present disclosure.

In S41, both the electronic apparatus 100 and the neighboring electronic apparatus broadcast an SSB. In S42, the user equipment UEa measures an RSRP of the SSB and records a corresponding cell ID. In S43, the electronic apparatus 100 receives the RSRP and the corresponding cell ID reported by the user equipment UEa. In S44, the electronic apparatus 100 schedules the user equipment UEa and calculates a ratio at based on RSRP information reported by the user equipment UEa, and generates RNTP signaling based on the ratio at. In S45, the electronic apparatus 100 sends the generated RNTP signaling to the neighboring electronic apparatus. In S46, the neighboring electronic apparatus schedules user equipment served by the neighboring electronic apparatus based on the received RNTP signaling, to avoid inter-cell interference.

Hereinafter, for simplicity, the RNTP signaling according to the embodiments of the present disclosure is sometimes referred to as enhanced RNTP signaling, and a bitmap of the enhanced RNTP signaling is referred to simply as an enhanced RNTP bitmap. In combination with the above description, it can be seen that the enhanced RNTP signaling according to the embodiment of the present disclosure is conducive to a fuller utilization of time-frequency resources in a case of high loads.

As an example, the electronic apparatus 100 and the neighboring electronic apparatus may be baseband processing units (BBUs) in a D-MIMO system.

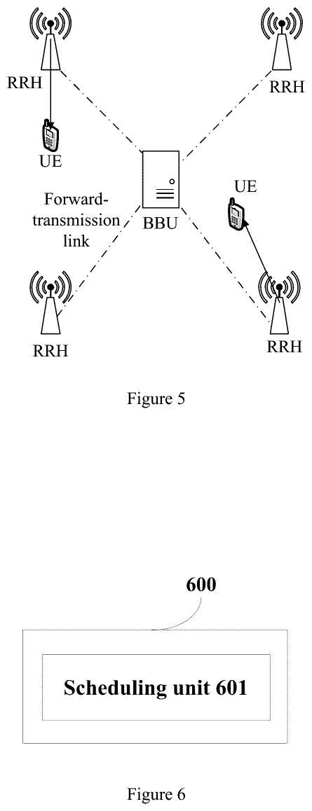

FIG. 5 is an example illustrating a D-MIMO system. As shown in FIG. 5, unlike a traditional centralized multi-antenna system, antennas of cells in the D-MIMO system are deployed in multiple RRHs at different geographic locations. Each of the RRHs may be equipped with multiple antennas, and the antennas are all connected via a forward-transmission link to a same BBU and serve a same cell. Processing of transmitting signals and receiving signals are all transmitted from the RRH to the BBU, and then centrally processed by the BBU. As the antennas in the D-MIMO system are dispersed and deployed inside the cell, an average distance from the UE to a cell antenna is significantly shortened, and a power required to serve the UE is reduced, resulting in an increase in an energy efficiency of the system. The D-MIMO provides better quality of service for cell-edge UE. Hence, coverage of the cell is improved.

An electronic apparatus for wireless communications is further provided according to another embodiment of the present disclosure. FIG. 6 shows a block diagram of functional modules of an electronic apparatus 600 for wireless communications according to another embodiment of the present disclosure.

As shown in FIG. 6, the electronic apparatus 600 includes a scheduling unit 601. The scheduling unit 601 may be configured to: perform scheduling based on RNTP signaling received from a neighboring electronic apparatus in proximity to the electronic apparatus 600, where the neighboring electronic apparatus sets, in the RNTP signaling, following indication information included in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, where the indication information is utilized to indicate a degree to which the user equipment scheduled by the neighboring electronic apparatus on the resource block is interfered by the electronic apparatus 600.

The scheduling unit 601 may be implemented by one or more processing circuits. The processing circuitry may be implemented as a chip, for example.

The electronic apparatus 600 may serve as a network-side apparatus in a wireless communication system, and may be specifically provided on a base station side or be communicatively connected to the base station, for example. Here, it should be noted that the electronic apparatus 600 may be implemented at a chip level or at an apparatus level. For example, the electronic apparatus 600 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment, another base station, and the like). An implementation of the transceiver is not specifically limited here.

The base station may be an eNB or gNB, as an example.

The wireless communication system according to the present disclosure may be a 5G NR communication system. Further, the wireless communication system according to the present disclosure may include a non-terrestrial network. Alternatively, the wireless communication system according to the present disclosure may further include a terrestrial network. In addition, those skilled in the art can understand that the wireless communication system according to the present disclosure may be a 4G or 3G communication system.

For example, the neighboring electronic apparatus in proximity to the electronic apparatus 600, as mentioned in the embodiment of the electronic apparatus 600, may correspond to the electronic apparatus 100 described in the embodiment of the electronic apparatus 100. The user equipment within a service range of the neighboring electronic apparatus, as mentioned in the embodiment of the electronic apparatus 600, may correspond to the user equipment UEa described in the embodiment of the electronic apparatus 100. The electronic apparatus 600 may correspond to the neighboring electronic apparatus Eq described in the embodiment of the electronic apparatus 100. The RNTP signaling in the embodiment of the electronic apparatus 600 may correspond to the RNTP signaling described in the embodiment of the electronic apparatus 100. The indication information in the embodiment of the electronic apparatus 600 may correspond to the indication information described in the embodiment of the electronic apparatus 100 (e.g., the “additional bit” in Table 1).

In an embodiment according to the present disclosure, based on the indication information that is included in the received RNTP signaling and that indicates the degree to which the user equipment scheduled by the neighboring electronic apparatus on the resource block is interfered by the electronic apparatus 600, the electronic apparatus 600 can determine an interference condition correctly during the scheduling. Hence, the communication performance can be improved.

As an example, the neighboring electronic apparatus is capable of communicating with the electronic apparatus 600 through an X2 interface.

As an example, the channel quality includes a reference signal received power or a signal to interference and noise ratio of a reference signal. Those skilled in the art may envisage other indications of the channel quality, which are not described here.

As an example, the report information includes a cell ID of a cell to which the electronic apparatus 600 belongs and a cell ID of a cell to which the neighboring electronic apparatus belongs.

As an example, the degree of interference is determined by using a ratio of channel quality corresponding to the neighboring electronic apparatus to channel quality corresponding to the electronic apparatus 600. Details about the ratio of channel quality corresponding to the electronic apparatus 600 to channel quality corresponding to the neighboring electronic apparatus may refer to the description in the embodiment of the electronic apparatus 100 in conjunction with equation (1), which is not repeated here.

Hereinafter, the neighboring electronic apparatus in proximity to the electronic apparatus 600 is sometimes referred to as a neighboring electronic apparatus Eq′, for simplicity. Description is made by way of an example in which the electronic apparatus 600 and the neighboring electronic apparatus Eq′ are implemented as base stations.

As an example, determination of the degree of interference is performed based on a comparison of the first predetermined threshold to the ratio. Other ways of determining the degree of interference based on the ratio may be envisaged by those skilled in the art and are not described in detail here.

As an example, in the RNTP signaling, the information corresponding to the resource block further includes power information indicating whether the neighboring electronic apparatus schedules the user equipment on the resource block at a transmit power higher than a second predetermined threshold.

The power information may be represented by bits corresponding to the resource block in a bitmap included in the RNTP signaling. A bit “0” indicates that the transmit power of the neighboring electronic apparatus on the resource block remains lower than the second predetermined threshold; and otherwise, it is indicated that the transmit power of the neighboring electronic apparatus on the resource block is higher than the second predetermined threshold.

Generally, a base station schedules a center user within a cell to which the base station belongs at a low power and an edge user within the cell at a high power.

For example, those skilled in the art may predetermine the second predetermined threshold based on experience, application scenarios, experiments, and the like.

As an example, the scheduling unit 601 may be configured to: schedule central user equipment in a cell to which the electronic apparatus belongs on the resource block at a transmit power higher than a third predetermined threshold, or schedule edge user equipment in the cell which is not interfered by the neighboring electronic apparatus on the resource block at a transmit power higher than the third predetermined threshold, in a case where the power information indicates that the neighboring electronic apparatus schedules the user equipment on the resource block at a transmit power higher than the second predetermined threshold and the indication information indicates a low degree of interference.

For example, those skilled in the art may predetermine the third predetermined threshold based on experience, application scenarios, experiments, and the like.

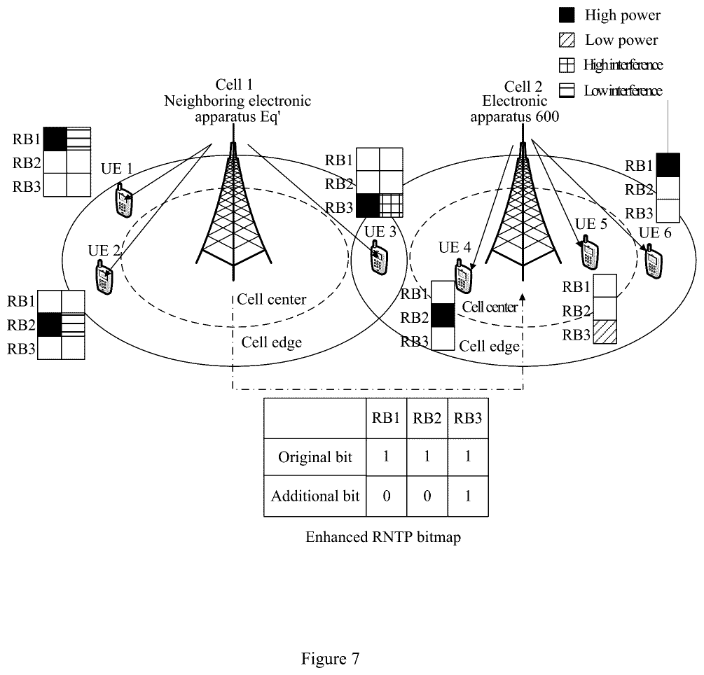

FIG. 7 illustrates an example of an electronic apparatus applying enhanced RNTP signaling for scheduling according to an embodiment of the present disclosure.

As shown in FIG. 7, it is assumed that the electronic apparatus 600 belongs to Cell 2 and the neighboring electronic apparatus Eq′ belongs to Cell 1. User equipment UE1, user equipment UE2 and user equipment UE3 are edge users of Cell 1. User equipment UE4 and user equipment UE5 are central users of Cell 2. User equipment UE6 is an edge user of Cell 2.

As shown in FIG. 7, the neighboring electronic apparatus Eq′ schedules the UE1 on a resource block RB1 at a high power, and therefore an original bit corresponding to the RB1 in the enhanced RNTP signaling is 1. The neighboring electronic apparatus Eq′ schedules the UE2 on a resource block RB2 at a high power, and therefore an original bit corresponding to the RB2 in the enhanced RNTP signaling is 1. The neighboring electronic apparatus Eq′ schedules the UE3 on a resource block RB3 at a high power, and therefore an original bit corresponding to the RB3 in the enhanced RNTP signaling is 1.

In addition, the neighboring electronic apparatus Eq′ sets an additional bit in the enhanced RNTP signaling based on information about channel quality in report information reported from the UE1, UE2, and UE3. For example, as shown in FIG. 7, the UE1 is far away from the electronic apparatus 600, and the ratio of channel quality between the UE1 and the neighboring electronic apparatus Eq′ to channel quality between the UE1 and the electronic apparatus 600 is greater than a first predetermined threshold. Therefore, the neighboring electronic apparatus Eq′ sets, in the enhanced RNTP signaling, an additional bit corresponding to the RB1 to 0 (indicating low interference on the UE1 from the electronic apparatus 600). The UE2 is far away from the electronic apparatus 600, and the ratio of channel quality between the UE2 and the neighboring electronic apparatus Eq′ to channel quality between the UE2 and the electronic apparatus 600 is greater than the first predetermined threshold. Therefore, the neighboring electronic apparatus Eq′ sets, in the enhanced RNTP signaling, an additional bit corresponding to the RB2 to 0 (indicating low interference on the UE2 from the electronic apparatus 600). The UE3 is located in an intersection area of a service range of the neighboring electronic apparatus Eq′ and a service range of the electronic apparatus, and the ratio of channel quality between the UE3 and the neighboring electronic apparatus Eq′ to channel quality between the UE3 and the electronic apparatus 600 is less than or equal to the first predetermined threshold. Therefore, the neighboring electronic apparatus Eq′ sets, in the enhanced RNTP signaling, an additional bit corresponding to the RB3 to 1 (indicating high interference on the UE3 from the electronic apparatus 600). The enhanced RNTP bitmap including the original bit and the added bit is shown in FIG. 7.

The neighboring electronic apparatus Eq′ sends the generated enhanced RNTP signaling as described above to the electronic apparatus 600 through an X2 interface. In the enhanced RNTP signaling, the original bit corresponds to RB1 is “1” and the additional bit corresponds to RB1 is “0”, indicating that the neighboring electronic apparatus Eq′ schedules the user equipment UE1 on the RB1 at a high power and the user equipment UE1 scheduled by the neighboring electronic apparatus Eq′ on the RB1 is interfered by the electronic apparatus 600 at a low degree. Hence, the electronic apparatus 600 can schedule, on the RB1 at a high power, the edge user equipment UE6 which is in Cell 2 and is not interfered by the neighboring electronic apparatus Eq′. This is because that there is actually no high degree of interference on the UE1 caused by the electronic apparatus 600 or no high degree of interference on the UE6 caused by the neighboring electronic apparatus Eq′, so that quality of service of the UE1 and the UE6 can be both guaranteed. In addition, in the enhanced RNTP signaling, the original bit corresponds to RB2 is “1” and the additional bit corresponds to RB2 is “0”, indicating that the neighboring electronic apparatus Eq′ schedules the user equipment UE2 on the RB2 at a high power and the user equipment UE2 scheduled by the neighboring electronic apparatus Eq′ on the RB2 is interfered by the electronic apparatus 600 at a low degree. Hence, the electronic apparatus 600 can schedule, on the RB2 at a high power, the central user equipment UE4 in Cell 2. This is because that there is actually no high degree of interference on the UE2 caused by the electronic apparatus 600 and the quality of service of UE4 can be improved. Moreover, in the enhanced RNTP signaling, the original bit corresponds to RB3 is “1” and the additional bit corresponds to RB3 is “1”, indicating that the neighboring electronic apparatus Eq′ schedules the user equipment UE3 on the RB3 at a high power and the user equipment UE3 scheduled by the neighboring electronic apparatus Eq′ on the RB3 is interfered by the electronic apparatus 600 at a high degree. Hence, the electronic apparatus 600 schedules the UE5 on the RB3 at a low power.

In FIG. 7, in a case that the electronic apparatus 600 performs scheduling by using the conventional RNTP signaling, the UE4 is served at a low power, and thereby the UE6 is also served at a low power since all RBs are restricted from transmitting at a high power by the conventional RNTP signaling. It can be seen that the application of the enhanced RNTP signaling according to the embodiment of the present disclosure can significantly improve performance of the system.

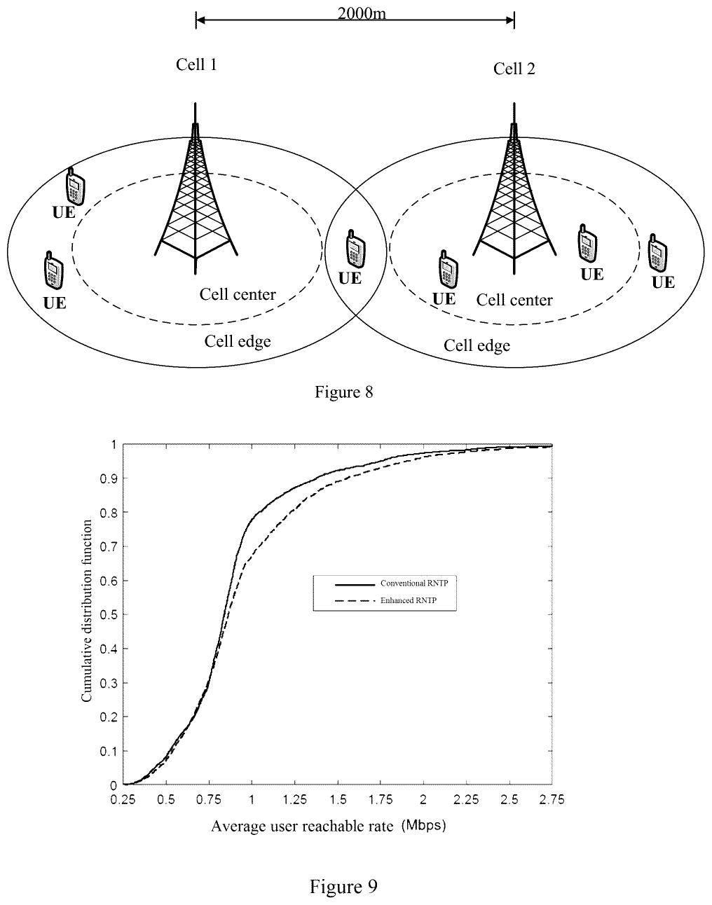

FIG. 8 illustrates an example of a simulation of a conventional cellular network scenario in which enhanced RNTP signaling according to an embodiment of the present disclosure is applied. In FIG. 8, two service cells (Cell 1 and Cell 2) are considered, where each of the service cells has a single-antenna base station at the center. A distance between two base stations is 2000 m. There are 100 UEs in each cell, and each UE is equipped with a single antenna. It is considered that the UEs are uniformly and randomly distributed in a coverage of the cell. A carrier frequency is 2 Ghz and a communication bandwidth is 20 MHz. There are 100 RBs and each user equipment is assigned one RB. A noise power spectral density is −174 dBm/Hz and a noise figure is 5 dB. A path loss model is 128.1+37.6 log₁₀(d), where d denotes a distance, in km. Short-term channel fading is modeled using the Rayleigh model. A total transmit power of each base station is set to 43 dBm.

FIG. 9 illustrates a plot of a cumulative distribution function (CDF) of an average user reachable rate obtained by applying enhanced RNTP signaling versus applying conventional RNTP signaling in a conventional cellular network scenario. As can be seen in FIG. 9, compared to the scheme with the conventional RNTP signaling, the scheme with the enhanced RNTP signaling enables a significant gain of an achievable rate and does not affect an achievable rate of a cell edge user.

As an example, the indication information in the enhanced RNTP signaling is further set by the neighboring electronic apparatus Eq′ based on beam information indicating whether the user equipment scheduled by the neighboring electronic apparatus on the resource block is within a range of a directional beam of the electronic apparatus 600.

In a case where the user equipment scheduled by the neighboring electronic apparatus Eq′ on the resource block is within a range of a directional beam of the electronic apparatus 600, the indication information may be set further based on the beam information, so that a degree of interference on the user equipment can be reflected more accurately.

As an example, the scheduling unit 601 may be configured to avoid scheduling user equipment that is aligned or close to a direction of the directional beam, in a case where the beam information indicates that the user equipment scheduled by the neighboring electronic apparatus Eq′ on the resource block is within the range of the directional beam of the electronic apparatus 600. In this way, the communication performance can be further improved.

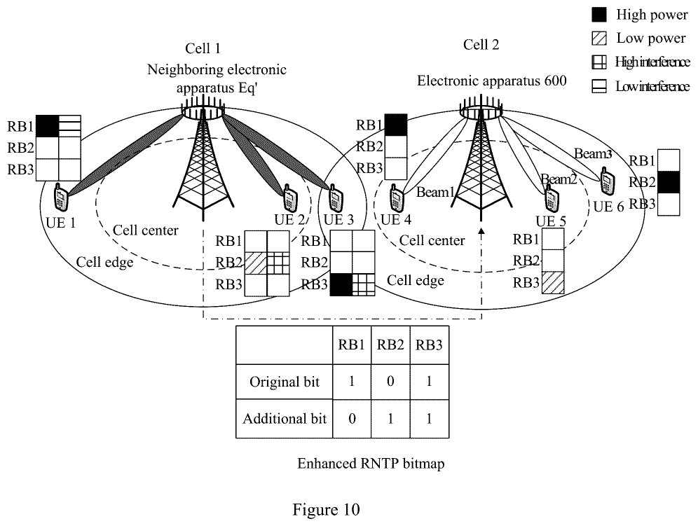

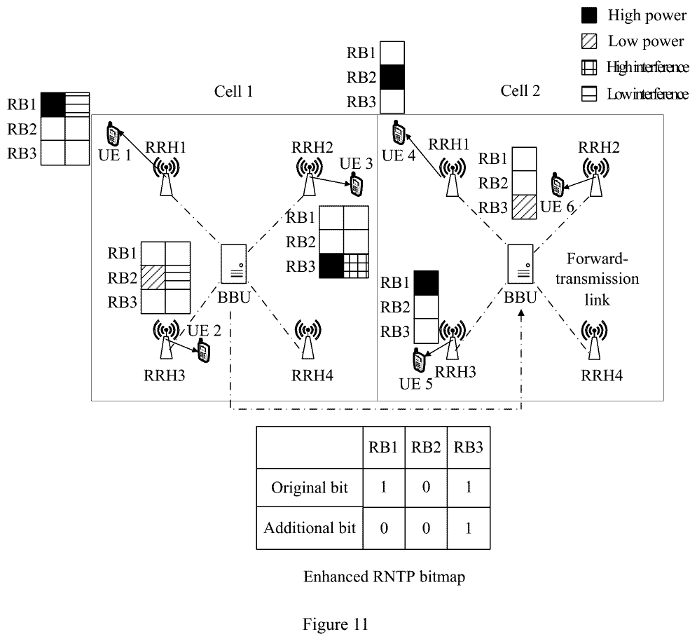

FIG. 10 illustrates an example of application of enhanced RNTP signaling in a multi-antenna highly directional beam scenario according to an embodiment of the present disclosure.

As shown in FIG. 10, it is assumed that the electronic apparatus 600 belongs to Cell 2 and the neighboring electronic apparatus Eq′ belongs to Cell 1. Each of the electronic apparatus 600 and the neighboring electronic apparatus Eq′ has multiple antennas, and therefore can form a directional beam. User equipment UE1 is an edge user of Cell 1; user equipment UE2 is a center user of Cell 1 and is in a range of beam 1 of the electronic apparatus 600; and user equipment UE3 is an edge user of Cell 1 and is in the range of beam 1 of electronic apparatus 600. User equipment UE4 and user equipment UE5 are central users of Cell 2. The user equipment UE3 and user equipment UE6 are edge users of Cell 2. The multiple antennas of the electronic apparatus 600 forms beam 1, beam 2, and beam 3.

As shown in FIG. 10, the neighboring electronic apparatus Eq′ schedules the UE1 on a resource block RB1 at a high power, and therefore an original bit corresponding to the RB1 in the enhanced RNTP signaling is 1. The neighboring electronic apparatus Eq′ schedules the UE2 on a resource block RB2 at a low power, and therefore an original bit corresponding to the RB2 in the enhanced RNTP signaling is 0. The neighboring electronic apparatus Eq′ schedules the UE3 on a resource block RB3 at a high power, and therefore an original bit corresponding to the RB3 in the enhanced RNTP signaling is 1.

In addition, the neighboring electronic apparatus Eq′ sets an additional bit in the enhanced RNTP signaling based on beam information and information about channel quality in report information reported from the UE1, UE2, and UE3. For example, as shown in FIG. 10, the UE1 is far away from the electronic apparatus 600 and is not within the range of a directional beam of the electronic apparatus 600. Therefore, the neighboring electronic apparatus Eq′ sets, in the enhanced RNTP signaling, an additional bit corresponding to the RB1 to 0 (indicating low interference on the UE1 from the electronic apparatus 600). The UE2 is far away from the electronic apparatus 600 and is within the range of a directional beam of the electronic apparatus 600. Therefore, the neighboring electronic apparatus Eq′ sets, in the enhanced RNTP signaling, an additional bit corresponding to the RB2 to 1 (indicating high interference on the UE2 from the electronic apparatus 600). The UE3 is in an intersection area of a service range of the neighboring electronic apparatus Eq′ and a service range of the electronic apparatus 600, and is within the range of a directional beam of the electronic apparatus 600. Therefore, the neighboring electronic apparatus Eq′ sets, in the enhanced RNTP signaling, an additional bit corresponding to the RB3 to 1 (indicating high interference on the UE3 from the electronic apparatus 600). An enhanced RNTP bitmap including the original bit and the added bit is shown in FIG. 10.

The neighboring electronic apparatus Eq′ sends the generated enhanced RNTP signaling as described above to the electronic apparatus 600 through an X2 interface. In the enhanced RNTP signaling, the original bit corresponds to RB1 is “1” and the additional bit corresponds to RB1 is “0”, indicating that the neighboring electronic apparatus Eq′ schedules the user equipment UE1 on the RB1 at a high power and the user equipment UE1 scheduled by the neighboring electronic apparatus Eq′ on the RB1 is interfered by the electronic apparatus 600 at a low degree. Hence, the electronic apparatus 600 can schedule, on the RB1 at a high power, the user equipment UE4 which is in Cell 2 and is not interfered by the neighboring electronic apparatus Eq′. This is because that there is actually no high degree of interference on the UE1 caused by the electronic apparatus 600 or no high degree of interference on the UE4 caused by the neighboring electronic apparatus Eq′. In addition, in the enhanced RNTP signaling, the original bit corresponds to RB2 is “0” and the additional bit corresponds to RB2 is “1”, indicating that the neighboring electronic apparatus Eq′ schedules the user equipment UE2 on the RB2 at a low power and the user equipment UE2 scheduled by the neighboring electronic apparatus Eq′ on the RB2 is interfered by the electronic apparatus 600 at a high degree. That is, it is indicated that the user equipment UE2 is a center user of the Cell 1 and is interfered by the electronic apparatus 600 at a high degree. This is because that the user equipment UE2 is in the range of the directional beam of the electronic apparatus 600. Hence, the electronic apparatus 600 avoids scheduling user equipment that is aligned or close to a direction of the directional beam 1, and, as shown in FIG. 10, the electronic apparatus 600 schedules, on the RB2 at a high power, the edge user equipment UE6 which is in the Cell 2 and deviates from the direction of the directional beam 1. Moreover, in the enhanced RNTP signaling, the original bit corresponds to RB3 is “1” and the additional bit corresponds to RB3 is “1”, indicating that the neighboring electronic apparatus Eq′ schedules the user equipment UE3 on the RB3 at a high power and the user equipment UE3 scheduled by the neighboring electronic apparatus Eq′ on the RB3 is interfered by the electronic apparatus 600 at a high degree. Hence, the electronic apparatus 600 schedules the UE5 on the RB3 at a low power. As shown in FIG. 10, the UE5 deviates from the direction of the directional beam 1.

As an example, the electronic apparatus 600 and the neighboring electronic apparatus Eq′ are BBUs in a D-MIMO system.

FIG. 11 illustrates an example application of enhanced RNTP signaling in a D-MIMO scenario according to an embodiment of the present disclosure. In the D-MIMO scenario, RRHs in D-MIMO are in reality difficult to synchronize due to capacity and latency of a forward link. Hence, it may be assumed that the user equipment selects the RRH closest to the user equipment to serve the user equipment.

As shown in FIG. 11, each of Cell 1 and Cell 2 is deployed with four RRHs (RRH1 to RRH4). For example, the neighboring electronic apparatus Eq′ is a BBU in Cell 1, and the electronic apparatus 600 is a BBU in Cell 2. In Cell 1, UE1 is a cell edge user and is served by the Cell 1 on RB1 at a high power, and the UE1 is interfered by the Cell 2 at a low degree. Therefore, in enhanced RNTP signaling, an original bit corresponds to RB1 is “1” and an additional bit corresponds to RB1 is “0”. UE2 is a cell center user and is served by the Cell 1 on RB2 at a low power, and the UE2 is interfered by the Cell 2 at a low degree. Therefore, in the enhanced RNTP signaling, an original bit corresponds to RB2 is “0” and an additional bit corresponds to RB2 is “0”. UE3 is a cell edge user and is served by Cell 1 on RB3 at a high power, and the UE3 is interfered by the Cell 2 at a high degree. Therefore, in enhanced RNTP signaling, an original bit corresponds to RB3 is “1” and an additional bit corresponds to RB3 is “1”.

The Cell 1 sends the bitmap of the enhanced RNTP signaling to the Cell 2. On reception of the RNTP signaling from Cell 1, Cell 2 serves the cell edge user UE4 at a high power and schedules the UE4 on the RB2, serves the cell center user UE5 at a high power and schedules the UE5 on the RB1, and serves the cell center user UE6 at a low power and schedules the UE6 on the RB3. Scheduling of the UE5 on the RB1 at a high power is usually not allowed when the scheduling is performed by using the conventional RNTP signaling. However, since the UE1 is subject to low interference from the Cell 2, the scheduling of the UE5 on the RB1 at a high power performed by the Cell 2 actually has less impact on the quality of service of the UE1 in the Cell 1.

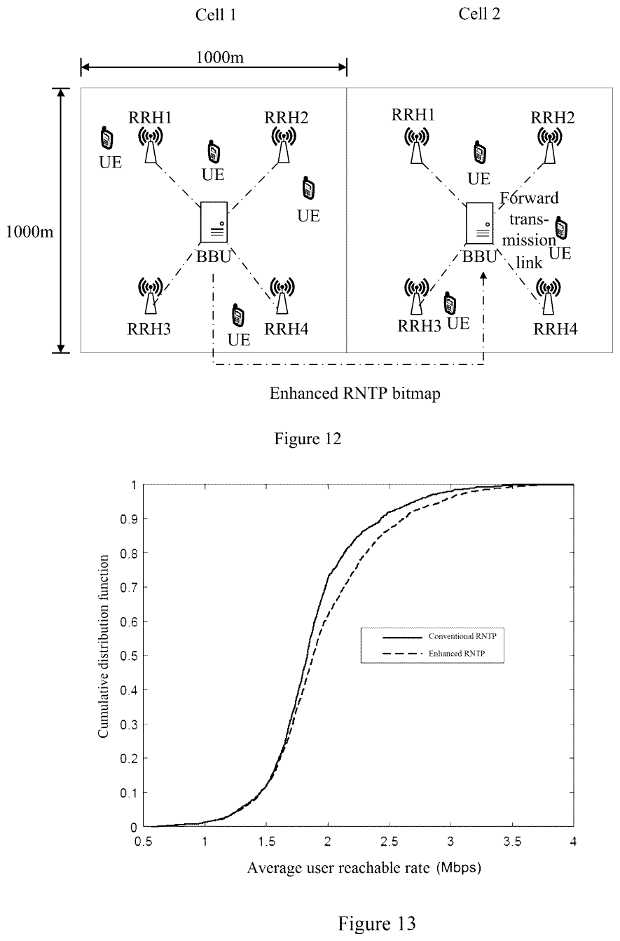

FIG. 12 illustrates an example of a simulation of a D-MIMO scenario in which enhanced RNTP signaling according to an embodiment of the present disclosure is applied. In FIG. 12, each of Cell 1 and Cell 2 is deployed with four RRHs (RRH1 to RRH4). Each RRH is equipped with four antennas. Each UE is equipped with a single antenna, and the UE selects only the RRH closest to the UE to serve the UE. A cell is a square area having a size of 1000 m*1000 m, and there are 100 UEs in each cell. A carrier frequency is 2 GHz, and a communication bandwidth is 20 MHz. There is a total of 100 RBs, and each UE is assigned one RB. A noise power spectral density is −174 dBm/Hz, and a noise figure is 5 dB. A path loss model is 128.1+37.6 log₁₀(d), where d denotes a distance, in km. Short-term channel fading is modeled using the Rayleigh model. A total transmit power of four RRHs in each cell is set to 30 dBm.

FIG. 13 illustrates a plot of a cumulative distribution function (CDF) of an average user reachable rate obtained by applying enhanced RNTP signaling versus applying conventional RNTP signaling in a D-MIMO scenario. As can be seen in FIG. 13, compared to the scheme with the conventional RNTP signaling, the scheme with the enhanced RNTP signaling enables a significant gain of an achievable rate.

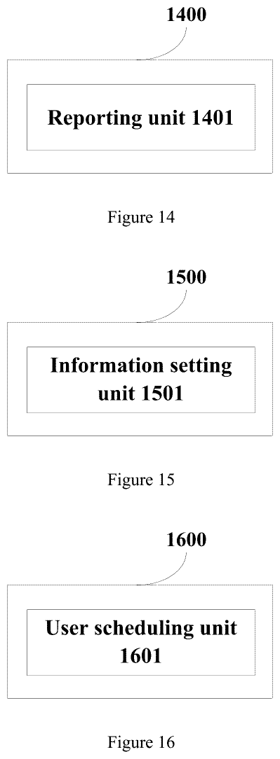

An electronic apparatus for wireless communications is further provided according to a further embodiment of the present disclosure. FIG. 14 shows a block diagram of functional modules of an electronic apparatus 1400 for wireless communications according to a further embodiment of the present disclosure.

As shown in FIG. 14, the electronic apparatus 1400 includes a reporting unit 1401. The reporting unit 1401 may be configured to: report, to a network-side apparatus that provides services for the electronic apparatus, report information that is based on channel quality between the electronic apparatus 1400 and the network-side apparatus and channel quality between the electronic apparatus 1400 and a neighboring network-side apparatus in proximity to the network-side apparatus, for the network-side apparatus to set following indication information included in information corresponding to a resource block in RNTP signaling to be sent to the neighboring network-side apparatus, where the indication information is utilized to indicate a degree to which the electronic apparatus 1400 scheduled by the network-side apparatus on the resource block is interfered by the neighboring network-side apparatus.

The reporting unit 1401 may be implemented by one or more processing circuits. The processing circuitry may be implemented as a chip, for example.

The electronic apparatus 1400 may, for example, be provided on a user equipment (UE) side or be communicatively connected to the user equipment. In a case where the electronic apparatus 1400 is provided on the user equipment side or communicatively connected to the user equipment, an apparatus related to the electronic apparatus 1400 may be user equipment. Here, it should be noted that the electronic apparatus 1400 may be implemented at a chip level or at an apparatus level. For example, the electronic apparatus 1400 may operate as the user equipment itself and may further include a memory, a transceiver (not shown), and other external devices. The memory may store related data information and programs that the user equipment needs to execute to achieve various functions. The transceiver may include one or more communication interfaces to support communications with different devices (such as a base station, another UE, and the like). An implementation of the transceiver is not specifically limited here.

As an example, the network side apparatus may be the electronic apparatus 100 mentioned above. As an example, the electronic apparatus 1400 may be the user equipment involved in the above embodiment of the electronic apparatus 100.

In an embodiment according to the present disclosure, the electronic apparatus 1400 reports the report information about channel quality to the network-side apparatus, so that the network-side apparatus indicates, in the RNTP signaling to be sent to the neighboring electronic apparatus, the degree to which the electronic apparatus scheduled on the resource block is interfered by the neighboring electronic apparatus. Therefore, an interference condition can be correctly reflected, and thereby a communication performance can be improved.

As an example, the degree to which the electronic apparatus 1400 scheduled by the network-side apparatus on the resource block is interfered by the neighboring network-side apparatus is determined by using a ratio of channel quality corresponding to the network-side apparatus to channel quality corresponding to the neighboring network-side apparatus. Details about the ratio of channel quality corresponding to the network-side apparatus to channel quality corresponding to the neighboring network-side apparatus may refer to the description in the embodiment of the electronic apparatus 100 in conjunction with equation (1), which is not repeated here.

As an example, the reporting unit 1401 may be configured to calculate the ratio and include the ratio in the report information, for the network-side apparatus to set the indication information based on the ratio.

As an example, the reporting unit 1401 may be configured to obtain initial information indicating the degree of interference based on a comparison of the ratio to a first predetermined threshold, and include the initial information in the report information, for the network-side apparatus to set the indication information based on the initial information. Reference may be made to the description of the initial information in the embodiment of the electronic apparatus 100, which is not repeated here.

An electronic apparatus for wireless communications is further provided according to a further embodiment of the present disclosure. FIG. 15 shows a block diagram of functional modules of an electronic apparatus 1500 for wireless communications according to a further embodiment of the present disclosure.

As shown in FIG. 15, the electronic apparatus 1500 includes an information setting unit 1501. The information setting unit 1501 may be configured to: set following power information included in information corresponding to a resource block in RNTP signaling to be sent to a neighboring electronic apparatus in proximity to the electronic apparatus 1500, where the power information is utilized to indicate, for each of multiple remote radio head (RRHs) in a cell to which the electronic apparatus 1500 belongs, whether the RRH schedules user equipment on the resource block at a transmit power higher than a fourth predetermined threshold.

The information setting unit 1501 may be implemented by one or more processing circuits. The processing circuitry may be implemented as a chip, for example.

The electronic apparatus 1500 may serve as a network-side apparatus in a wireless communication system, and may be specifically provided on a base station side or be communicatively connected to the base station, for example. Here, it should be noted that the electronic apparatus 1500 may be implemented at a chip level or at an apparatus level. For example, the electronic apparatus 1500 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment, another base station, and the like). An implementation of the transceiver is not specifically limited here.

The base station may be an eNB or gNB, as an example.

Hereinafter, the RNTP signaling for indicating whether each RRH schedules user equipment on a resource block at a transmit power higher than a fourth predetermined threshold, in accordance with the embodiments of the present disclosure, is sometimes referred to as D-MIMO enhanced RNTP signaling.

It is assumed that there are K (K is a positive integer greater than or equal to 2) RRHs in the cell to which the electronic apparatus 1500 belongs. In an embodiment according to the present disclosure, the power information included in the information corresponding to an RB in the bitmap included in the D-MIMO enhanced RNTP signaling has K bits, where each of the bits corresponds to an RRH. Each bit indicates whether a transmit power of a corresponding RRH on the RB exceeds the fourth predetermined threshold. For example, a bit “1” indicates that the transmit power of a corresponding RRH on the RB is greater than the fourth predetermined threshold, and a bit “0” indicates that the transmit power of a corresponding RRH on the RB is less than or equal to the fourth predetermined threshold.

For example, those skilled in the art may predetermine the fourth predetermined threshold based on experience, application scenarios, experiments, and the like.

Different RRHs in the cell cause different degrees of ICI to a neighboring cell. The conventional RNTP signaling cannot make full use of geographic differences of the RRHs, and can reflect only an overall situation of all the RRHs, but cannot reflect situations of the transmit power for the different RRHs. In this case, the neighboring cell is easily to mis-determine the interference situation, which degrades the communication performance.

However, as shown in FIG. 12, in a case where an RRH1 in the Cell 1 serves a relevant user, due to long distances from the RRH1 to each of an RRH2, RRH3, and RRH4 in Cell 2, the RRH1 in the Cell 1 causes less interference to UEs served by the RRH2, RRH3, and RRH4 in the Cell 2. Even if the RRH1 in the Cell 1 transmits at a high power, a strong ICI is not to be caused on the UEs served by the RRH2, RRH3, and RRH4 in the Cell 2. Therefore, in an embodiment according to the present disclosure, the electronic apparatus 1500 reflects, in the RNTP signaling, condition of the transmit power about different RRHs. Different degrees of interference caused by different RRHs to the cell to which the neighboring electronic apparatus belongs can be reflected correctly. Hence, for example, the neighboring electronic apparatus considers the interference condition during scheduling, and thereby the communication performance is improved.

For example, the user equipment may be served by any combination of RRHs in the cell to which the user equipment belongs. As an example, the user equipment may be served by an RRH which is closest to the user equipment.

As an example, the electronic apparatus 1500 and the neighboring electronic apparatus are BBUs in a D-MIMO system.

An electronic apparatus for wireless communications is further provided according to a further embodiment of the present disclosure. FIG. 16 shows a block diagram of functional modules of an electronic apparatus 1600 for wireless communications according to a further embodiment of the present disclosure.

As shown in FIG. 16, the electronic apparatus 1600 includes a user scheduling unit 1601. The user scheduling unit 1601 may be configured to: perform scheduling based on RNTP signaling received from a neighboring electronic apparatus in proximity to the electronic apparatus 1600, where the neighboring electronic apparatus sets following power information included in information corresponding to a resource block in the RNTP signaling, the power information is utilized to indicate, for each of multiple RRHs in a cell to which the neighboring electronic apparatus belongs, whether the RRH schedules user equipment on the resource block at a transmit power higher than a fourth predetermined threshold, and a cell to which the electronic apparatus 1600 belongs includes multiple RRHs.

The user scheduling unit 1601 may be implemented by one or more processing circuits. The processing circuitry may be implemented as a chip, for example.

The electronic apparatus 1600 may serve as a network-side apparatus in a wireless communication system, and may be specifically provided on a base station side or be communicatively connected to the base station, for example. Here, it should be noted that the electronic apparatus 1600 may be implemented at a chip level or at an apparatus level. For example, the electronic apparatus 1600 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment, another base station, and the like). An implementation of the transceiver is not specifically limited here.

The base station may be an eNB or gNB, as an example.

For example, the electronic apparatus 1600 corresponds to the neighboring electronic apparatus in the embodiment of the electronic apparatus 1500; and the neighboring electronic apparatus in the embodiment of the electronic apparatus 1600 corresponds to the electronic apparatus 1500 in the embodiment of the electronic apparatus 1500.

In an embodiment according to the present disclosure, based on the power information that is included in the received RNTP signaling and that indicates a condition of the transmit power of different RRHs in the neighboring electronic apparatus, the electronic apparatus 1600 can determine interference conditions of different RRHs in the neighboring electronic apparatus correctly during the scheduling. Hence, the communication performance can be improved.

As an example, the user scheduling unit 1601 may be configured to ignore, during the scheduling, power information which is included in the RNTP signaling and corresponds to an RRH at a distance greater than a fifth predetermined threshold from an RRH that serves to-be-scheduled user equipment.

For example, those skilled in the art may predetermine the fifth predetermined threshold based on experience, application scenarios, experiments, and the like.

For example, the to-be-scheduled user equipment may be served by any combination of RRHs in the cell to which the to-be-scheduled user equipment belongs. As an example, the to-be-scheduled user equipment may be served by an RRH which is closest to the to-be-scheduled user equipment.

As an example, the electronic apparatus 1600 and the neighboring electronic apparatus are BBUs in a D-MIMO system.

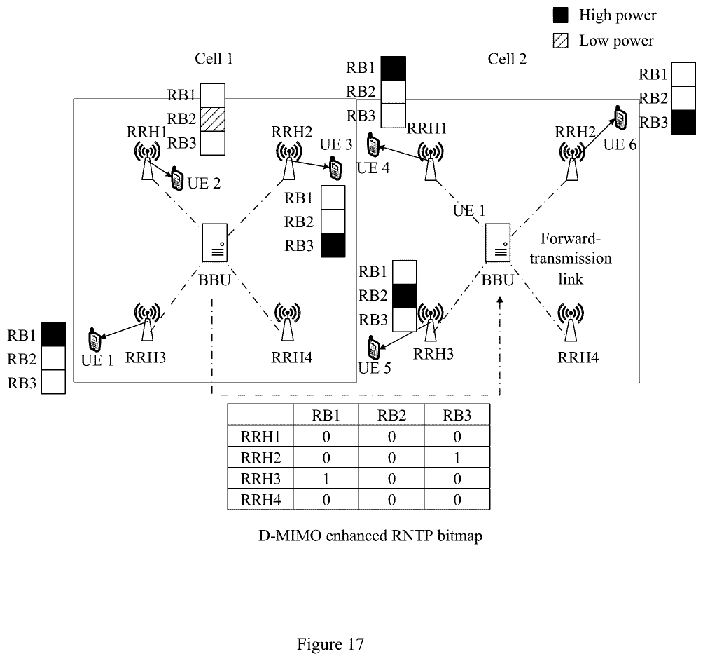

FIG. 17 illustrates an example of scheduling based on D-MIMO enhanced RNTP signaling for the electronic apparatus 1600 according to an embodiment of the present disclosure.

As shown in FIG. 17, the electronic apparatus 1600 belongs to Cell 2 and the neighboring electronic apparatus belongs to Cell 1. Each of the Cell 1 and the Cell 2 is deployed with four RRHs (RRH1 to RRH4). UE1, UE2, and UE3 in the Cell 1 are served by RRH3, RRH1, and RRH2, respectively. The UE1 and the UE3 are cell edge user equipment, and therefore are served by the Cell 1 on RB1 and RB3, respectively, at a high transmit power. The UE2 is cell center user equipment, and is served by the Cell 1 on RB2 at a low transmit power. Therefore, in the bitmap included in the D-MIMO enhanced RNTP signaling according to the embodiment of the present disclosure: on the RB1, the RRH1 corresponds to a bit 0, the RRH2 corresponds to a bit 0, the RRH3 corresponds to a bit 1, and the RRH4 corresponds to a bit 0; on the RB2, the RRH1 corresponds to a bit 0, the RRH2 corresponds to a bit 0, the RRH3 corresponds to a bit 0, and the RRH4 corresponds to a bit 0; and on the RB3, the RRH1 corresponds to a bit 0, the RRH2 corresponds to a bit 1, the RRH3 corresponds to a bit 0, and the RRH4 corresponds to a bit 0. It can be seen that the D-MIMO enhanced RNTP signaling according to the embodiment of the present disclosure better reflects a specific situation of the transmit power of the RRHs in the cell. The bitmap of the D-MIMO enhanced RNTP signaling described above (D-MIMO enhanced RNTP bitmap) is illustrated in FIG. 17.

On reception of the D-MIMO enhanced RNTP signaling from the Cell 1, the Cell 2 performs scheduling to schedule the cell edge user equipment UE4, UE5, and UE6 on the RB1, RB2, and RB3, respectively, at a high power. As can be seen from the scheduling of the Cell 2, the Cell 2, when scheduling, ignores the bit “1” in the D-MIMO enhanced RNTP signaling corresponding to the RRH3 in the Cell 1 at a distance greater than a fifth predetermined threshold from the RRH1 in the Cell 2 which provides service to the to-be-scheduled user equipment UE4, and ignores the bit “1” in the D-MIMO enhanced RNTP signaling corresponding to the RRH2 in the Cell 1 at a distance greater than the fifth predetermined threshold from the RRH2 in the Cell 2 which provides service to the to-be-scheduled user equipment UE6. Thereby, flexibility of the scheduling of the electronic apparatus 1600 in the Cell 2 is improved.

Combined with FIG. 17, it can be seen that since the multiple antennas of a cell in the D-MIMO are distributed over a number of RRHs at different geographic locations, when a certain RRH in the Cell 1 transmitting the RNTP signaling is far away from a certain RRH in the Cell 2 receiving the RNTP signaling, there is less interference to the UE served by the RRH corresponding to the Cell 2 receiving the RNTP signaling. Therefore, the Cell 2 receiving the RNTP signaling may ignore the bit corresponding to a distant RRH in the bitmap included in the RNTP signaling when scheduling UE served by different RRHs. Hence, more flexible scheduling is realized.

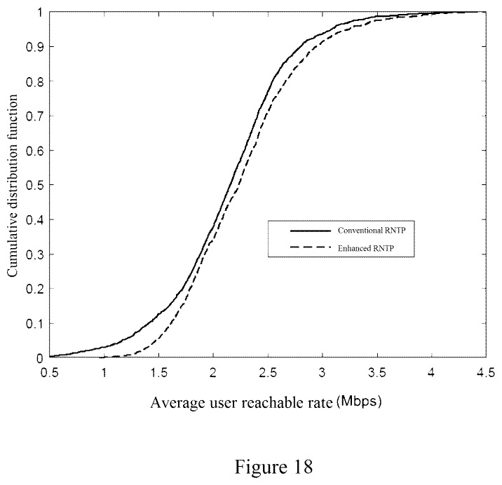

FIG. 18 illustrates a plot of a cumulative distribution function (CDF) of an average user reachable rate obtained by applying D-MIMO enhanced RNTP signaling versus applying conventional RNTP signaling in a D-MIMO scenario. A simulation scenario is as shown in FIG. 12 and a parameter configuration is the same as described above in conjunction with FIG. 12. As can be seen in FIG. 18, compared to the scheme with the conventional RNTP signaling, the scheme with the D-MIMO enhanced RNTP signaling realizes increase of a minimum user rate and a significant increase of an overall average user rate of the system.

Additionally, in combination with the above description, it can be seen that the D-MIMO enhanced RNTP signaling according to the embodiment of the present disclosure is conducive to a fuller utilization of time-frequency resources in a case of high loads.

In the description of the electronic apparatuses for wireless communications in the above embodiments, some processes or methods are further disclosed. Hereinafter, an overview of the methods is given without repeating some of details discussed above. It should be noted that although disclosed in the description of the electronic apparatuses for wireless communications, the methods do not necessarily adopt the components as described or be performed by those components. For example, an embodiment of the electronic apparatus for wireless communications may be implemented partially or entirely using hardware and/or firmware, while a method for wireless communications discussed below may be implemented entirely by a computer-executable program, although the method may employ the hardware and/or firmware for the electronic apparatus for wireless communications.

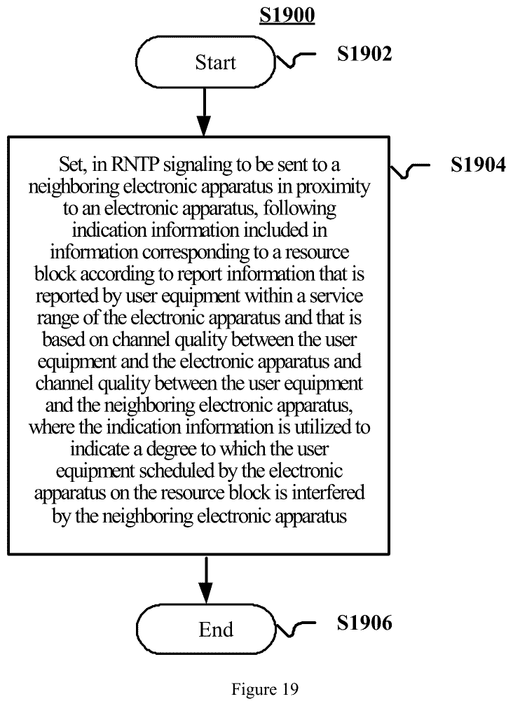

FIG. 19 shows a flow chart of a method S1900 for wireless communications according to an embodiment of the present disclosure. The method S1900 starts from step S1902. In step S1904, following indication information included in information corresponding to a resource block is set, in RNTP signaling to be sent to a neighboring electronic apparatus in proximity to an electronic apparatus, according to report information that is reported by user equipment within a service range of the electronic apparatus and that is based on channel quality between the user equipment and the electronic apparatus and channel quality between the user equipment and the neighboring electronic apparatus, where the indication information is utilized to indicate a degree to which the user equipment scheduled by the electronic apparatus on the resource block is interfered by the neighboring electronic apparatus. The method S1900 ends at step S1906.

This method may be performed, for example, by the electronic apparatus 100 as described above. For specific details, reference may be made to description at a corresponding section above, which is not repeated here.

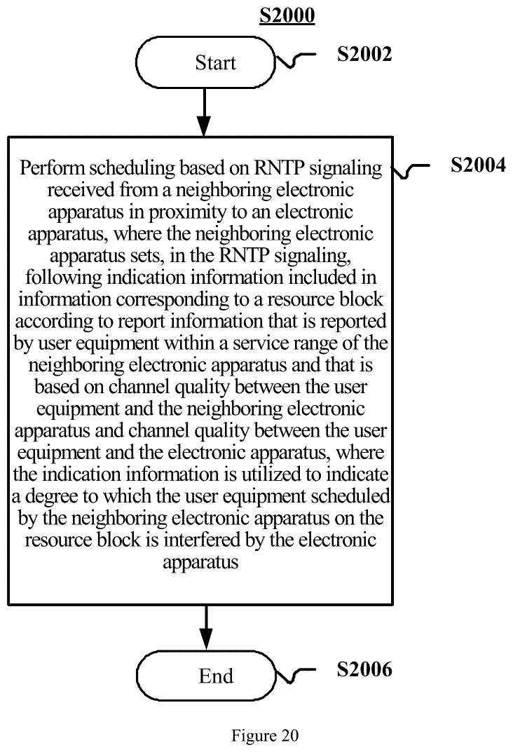

FIG. 20 shows a flow chart of a method S2000 for wireless communications according to an embodiment of the present disclosure. The method S2000 starts from step S2002. In step S2004, scheduling is performed based on RNTP signaling received from a neighboring electronic apparatus in proximity to an electronic apparatus, where the neighboring electronic apparatus sets, in the RNTP signaling, following indication information included in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, where the indication information is utilized to indicate a degree to which the user equipment scheduled by the neighboring electronic apparatus on the resource block is interfered by the electronic apparatus. The method S2000 ends at step S2006.

This method may be performed, for example, by the electronic apparatus 600 as described above. For specific details, reference may be made to description at a corresponding section above, which is not repeated here.

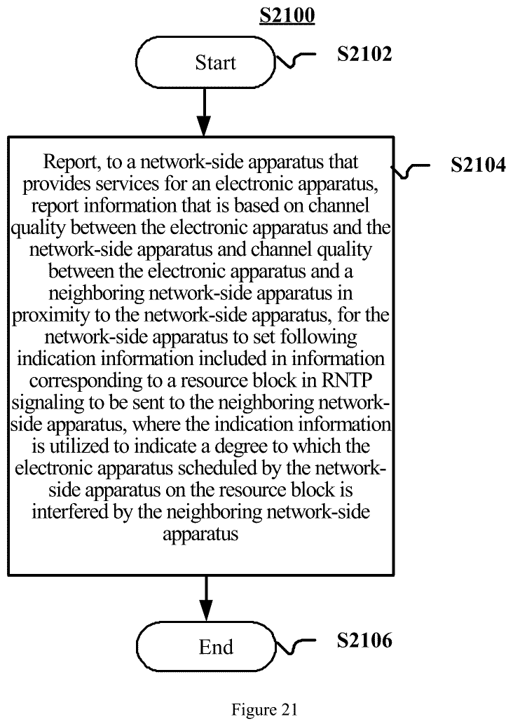

FIG. 21 shows a flow chart of a method S2100 for wireless communications according to an embodiment of the present disclosure. The method S2100 starts from step S2102. In step S2104, report information that is based on channel quality between an electronic apparatus and a network-side apparatus that provides services for the electronic apparatus and channel quality between the electronic apparatus and a neighboring network-side apparatus in proximity to the network-side apparatus is reported to the network-side apparatus, for the network-side apparatus to set following indication information included in information corresponding to a resource block in RNTP signaling to be sent to the neighboring network-side apparatus, where the indication information is utilized to indicate a degree to which the electronic apparatus scheduled by the network-side apparatus on the resource block is interfered by the neighboring network-side apparatus. The method S2100 ends at step S2106.

This method may be performed, for example, by the electronic apparatus 1400 as described above. For specific details, reference may be made to description at a corresponding section above, which is not repeated here.

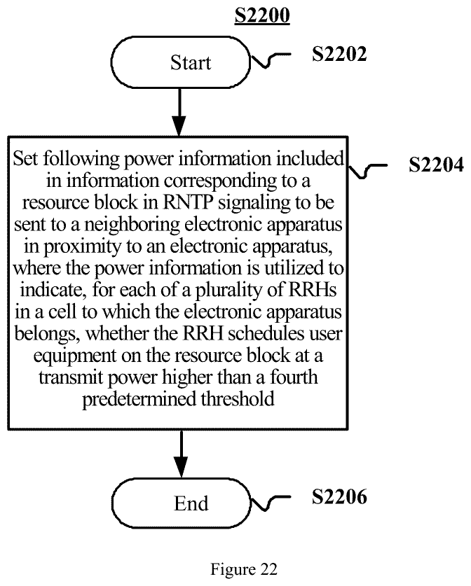

FIG. 22 shows a flow chart of a method S2200 for wireless communications according to an embodiment of the present disclosure. The method S2200 starts from step S2202. In step S2204, following power information included in information corresponding to a resource block is set in RNTP signaling to be sent to a neighboring electronic apparatus in proximity to an electronic apparatus, where the power information is utilized to indicate, for each of multiple RRHs in a cell to which the electronic apparatus belongs, whether the RRH schedules user equipment on the resource block at a transmit power higher than a fourth predetermined threshold. The method S2200 ends at step S2206.

This method may be performed, for example, by the electronic apparatus 1500 as described above. For specific details, reference may be made to description at a corresponding section above, which is not repeated here.

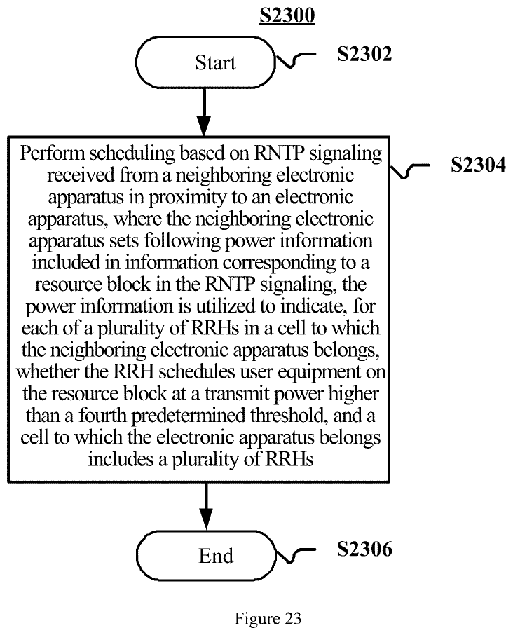

FIG. 23 shows a flow chart of a method S2300 for wireless communications according to an embodiment of the present disclosure. The method S2300 starts from step S2302. In step S2304, scheduling is performed based on RNTP signaling received from a neighboring electronic apparatus in proximity to an electronic apparatus, where the neighboring electronic apparatus sets following power information included in information corresponding to a resource block in the RNTP signaling, the power information is utilized to indicate, for each of multiple RRHs in a cell to which the neighboring electronic apparatus belongs, whether the RRH schedules user equipment on the resource block at a transmit power higher than a fourth predetermined threshold, and a cell to which the electronic apparatus belongs includes multiple RRHs. The method S2300 ends at step S2306.

This method may be performed, for example, by the electronic apparatus 1600 as described above. For specific details, reference may be made to description at a corresponding section above, which is not repeated here.

The technology of the present disclosure can be applied to various products.

The electronic apparatus 100, the electronic apparatus 600, the electronic apparatus 1500 and the electronic apparatus 1600 may be implemented as various network side apparatuses, such as base stations. The base station may be implemented as any type of evolved Node B (eNB) or gNB (5G base station). An eNB includes, for example, a macro eNB and a small eNB. A small eNB may be an eNB that covers a cell smaller than a macro cell, such as a pico eNB, a micro eNB, and a home (femto) eNB. A similar situation may apply to the gNB. Alternatively, the base station may be implemented in any other type, such as a NodeB and a base transceiver station (BTS). The base station may include: a main body (also referred to as base station equipment) configured to control wireless communications; and one or more remote radio heads (RRHs) arranged at a different place from the main body. In addition, various types of user equipment can all operate as base stations by temporarily or semi-persistently performing base station functions.

The electronic apparatus 1400 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may also be implemented as a terminal that performs machine-to-machine (M2M) communications (which is also referred to as a machine type communication (MTC) terminal). Furthermore, the user equipment may be a wireless communication module (such as an integrated circuit module including a single chip) installed on each of the above-mentioned terminals.

### [Application Examples of Base Station]

### (First Application Example)

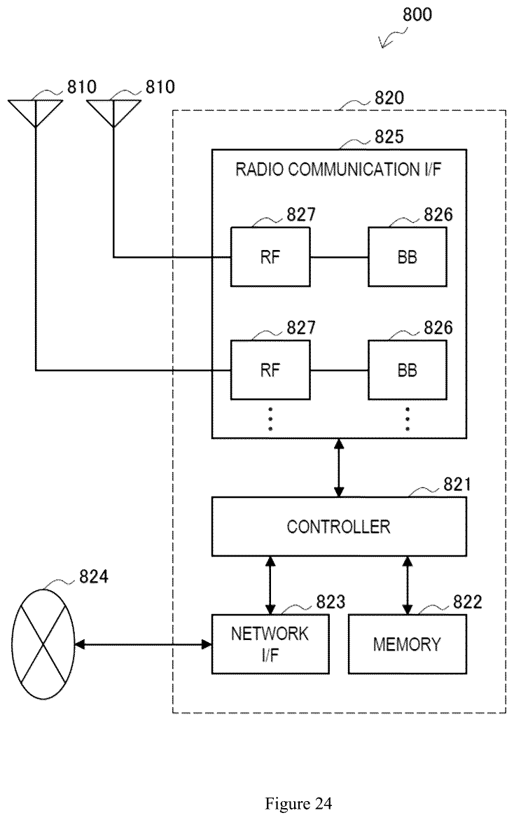

FIG. 24 is a block diagram showing a first example of a schematic configuration of an eNB or gNB to which the technology of the present disclosure may be applied. It should be noted that the following description is made taking an eNB as an example. The technology of the present disclosure is also applicable to a gNB. An eNB 800 includes one or more antennas 810 and base station equipment 820. The base station equipment 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station equipment 820 to transmit and receive wireless signals. As shown in FIG. 24, the eNB 800 may include multiple antennas 810. For example, the multiple antennas 810 may be compatible with multiple frequency bands used by the eNB 800. Although FIG. 24 shows an example in which the eNB 800 includes multiple antennas 810, the eNB 800 may include a single antenna 810.

The base station equipment 820 includes a controller 821, a memory 822, a network interface 823, and a radio communication interface 825.

The controller 821 may be, for example, a CPU or DSP, and operates various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or another eNB may be connected to each other through a logical interface (such as an SI interface and an X2 interface). The network interface 823 may be a wired communication interface or a wireless communication interface for a wireless backhaul line. In a case that the network interface 823 is a wireless communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 827. The BB processor 826 may perform, for example, coding/decoding, modulation/demodulation and multiplexing/de-multiplexing, and perform various types of signal processes of layers (for example, L1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station equipment 820. Alternatively, the module may be a chip mounted on the card or blade. In addition, the RF circuit 827 may include, for example, a mixer, a filter or an amplifier, and transmit and receive a wireless signal via the antenna 810.

As shown in FIG. 24, the radio communication interface 825 may include multiple BB processors 826. For example, the multiple BB processors 826 may be compatible with multiple frequency bands used by the eNB 800. As shown in FIG. 24, the radio communication interface 825 may include multiple RF circuits 827. For example, the multiple RF circuits 827 may be compatible with multiple antenna elements. Although FIG. 24 shows an example in which the radio communication interface 825 includes multiple BB processors 826 and multiple RF circuits 827, the radio communication interface 825 may include a single BB processor 826 or a single RF circuit 827.

In the eNB 800 as shown in FIG. 24, the electronic apparatuses 100, 600, 1500, and 1600, when implemented as base stations, have transceivers that may be implemented by the radio communication interface 825. At least a part of the functions may be implemented by the controller 821. For example, the controller 821 may make improvements to the conventional RNTP signaling by performing functions of the units in the electronic apparatuses 100, 600, 1500, and 1600.

### (Second Application Example)

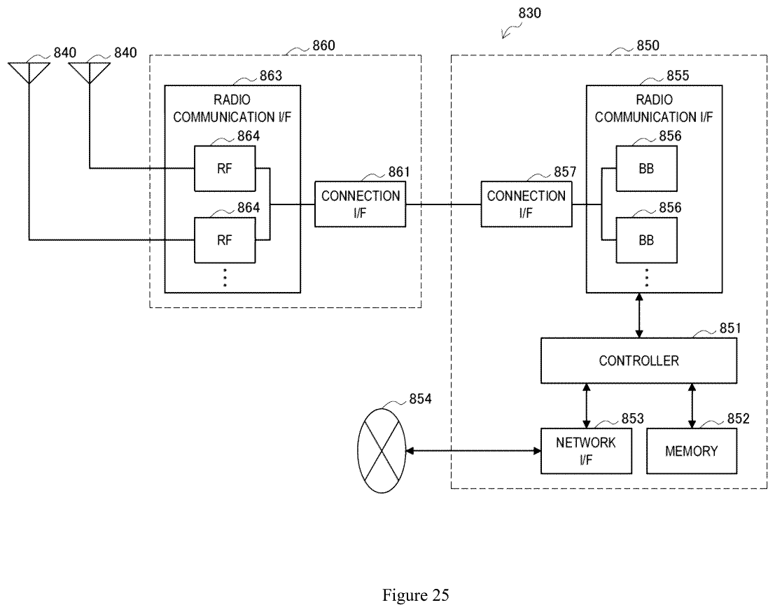

FIG. 25 is a block diagram showing a second example of a schematic configuration of an eNB or gNB to which the technology of the present disclosure may be applied. It should be noted that the following description is made taking the eNB as an example. The technology of the present disclosure is also applicable to the gNB. An eNB 830 includes a single or multiple antennas 840, base station equipment 850 and an RRH 860. The RRH 860 and each of the antennas 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 25, the eNB 830 may include multiple antennas 840. For example, the multiple antennas 840 may be compatible with multiple frequency bands used by the eNB 830. Although FIG. 25 shows an example in which the eNB 830 includes multiple antennas 840, the eNB 830 may include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 24.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 24, except that the BB processor 856 is connected to an RF circuit 864 of the RRH 860 via the connection interface 857. As shown in FIG. 25, the radio communication interface 855 may include multiple BB processors 856. For example, the multiple BB processors 856 may be compatible with multiple frequency bands used by the eNB 830. Although FIG. 25 shows an example in which the radio communication interface 855 includes multiple BB processors 856, the radio communication interface 855 may include a single BB processor 856.

The connection interface 857 is an interface for connecting the base station equipment 850 (the radio communication interface 855) to the RRH 860. The connection interface 857 may be a communication module for communication in the above-described high-speed line that connects the base station equipment 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station equipment 850. The connection interface 861 may also be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 25, the radio communication interface 863 may include multiple RF circuits 864. For example, the multiple RF circuits 864 may support multiple antenna elements. Although FIG. 25 shows an example in which the radio communication interface 863 includes multiple RF circuits 864, the radio communication interface 863 may include a single RF circuit 864.

In the eNB 830 as shown in FIG. 25, the electronic apparatuses 100, 600, 1500, and 1600, when implemented as base stations, have transceivers that may be implemented by the radio communication interface 855. At least a part of the functions may be implemented by the controller 851. For example, the controller 851 may make improvements to the conventional RNTP signaling by performing functions of the units in the electronic apparatuses 100, 600, 1500, and 1600.

### [Application Example of User Equipment]

### (First Application Example)

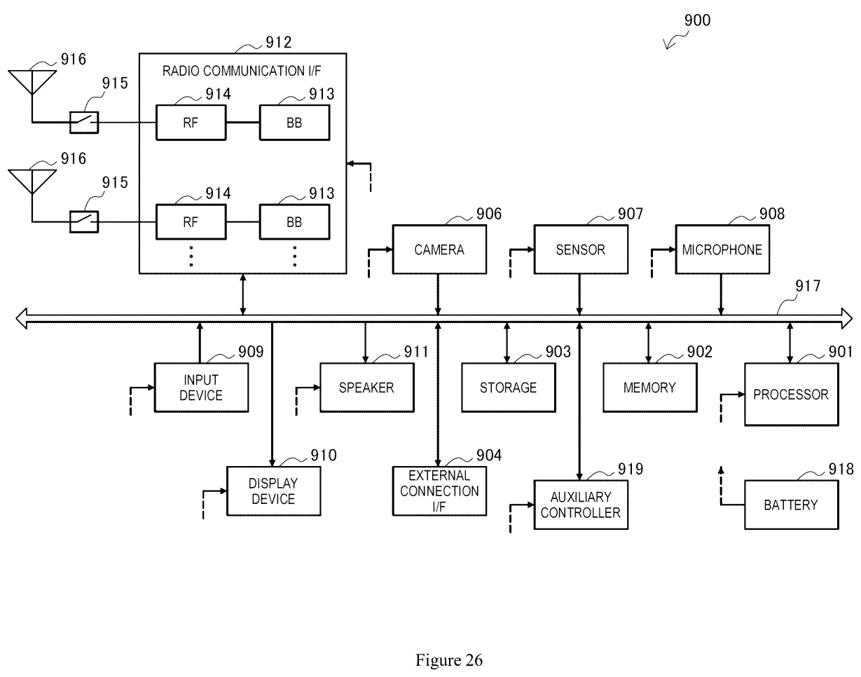

FIG. 26 is a block diagram showing an example of a schematic configuration of a smart phone 900 to which the technology of the present disclosure may be applied. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter or an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 26, the radio communication interface 912 may include multiple BB processors 913 and multiple RF circuits 914. Although FIG. 26 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 26, the smart phone 900 may include multiple antennas 916. Although FIG. 26 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 26 via a feeder line. The feeder line is partially shown as a dashed line in the figure. The auxiliary controller 919 operates the least necessary function of the smart phone 900 in a sleep mode, for example.

In the smart phone 900 as shown in FIG. 26, in a case where the electronic apparatuses 1400 is implemented, for example, as a smart phone on the user equipment side, the transceiver of the electronic apparatus 1400 may be implemented by the radio communication interface 912. At least part of the functions may be implemented by the processor 901 or the auxiliary controller 919. For example, the processor 901 or the auxiliary controller 919 may assist the network-side apparatus to make improvements to the conventional RNTP signaling by performing the function of the unit in the electronic apparatus 1400.

### (Second Application Example)

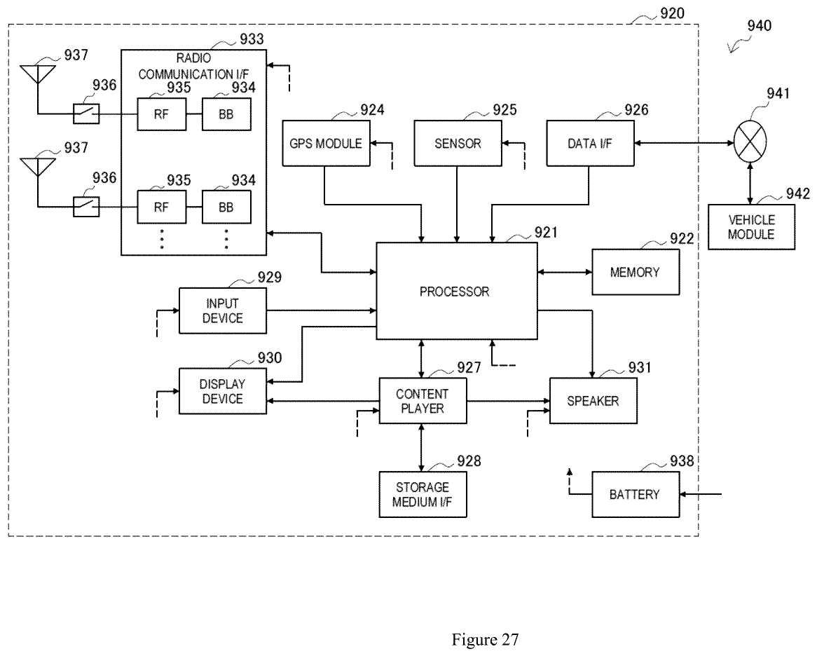

FIG. 27 is a block diagram showing an example of a schematic configuration of an automobile navigation device 920 to which the technology of the present disclosure may be applied. The automobile navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or SoC, and controls the navigation function of the automobile navigation device 920 and other functions. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD) inserted into the storage medium interface 928. The input device 929 includes, for example, a touch sensor configured to detect a touch on a screen of the display device 930, a button, or a switch, and receives an operation or information inputted from the user. The display device 930 includes a screen such as an LCD or OLED display, and displays an image of a navigation function or reproduced content. The speaker 931 outputs a sound of the navigation function or the reproduced content.

The radio communication interface 933 supports any cellular communication scheme (such as LTE and LTE-Advanced), and performs wireless communications. The radio communication interface 933 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter or an amplifier, and transmit and receive a wireless signal via the antenna 937. The radio communication interface 933 may be a chip module on which the BB processor 934 and the RF circuit 935 are integrated. As shown in FIG. 27, the radio communication interface 933 may include multiple BB processors 934 and multiple RF circuits 935. Although FIG. 27 shows an example in which the radio communication interface 933 includes multiple BB processors 934 and multiple RF circuits 935, the radio communication interface 933 may include a single BB processor 934 or a single RF circuit 935.

In addition to the cellular communication scheme, the radio communication interface 933 may support another type of wireless communication scheme, such as a short-range wireless communication scheme, a near field communication scheme, or a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 933.

Each of the antennas 937 includes a single or multiple antenna elements (such as multiple antenna elements included in a MIMO antenna), and is configured for the radio communication interface 933 to transmit and receive wireless signals. As shown in FIG. 27, the automobile navigation device 920 may include multiple antennas 937. Although FIG. 27 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 27 via a feeder line. The feeder line is partially shown as a dashed line in the figure. The battery 938 accumulates electric power supplied from the vehicle.

In the automobile navigation device 920 as shown in FIG. 27, in a case where the electronic apparatuses 1400 is implemented, for example, as an automobile navigation device on the user equipment side, the transceiver of the electronic apparatus 1400 may be implemented by the radio communication interface 933. At least part of the functions may be implemented by the processor 921. For example, the processor 921 may assist the network-side apparatus to make improvements to the conventional RNTP signaling by performing the function of the unit in the electronic apparatus 1400.

The technology of the present disclosure may also be implemented as an in-vehicle system (or vehicle) 940 including the automobile navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with specific embodiments. However, it should be noted that those skilled in the art can understand that all or any steps or components of the methods and apparatuses of the present disclosure can be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

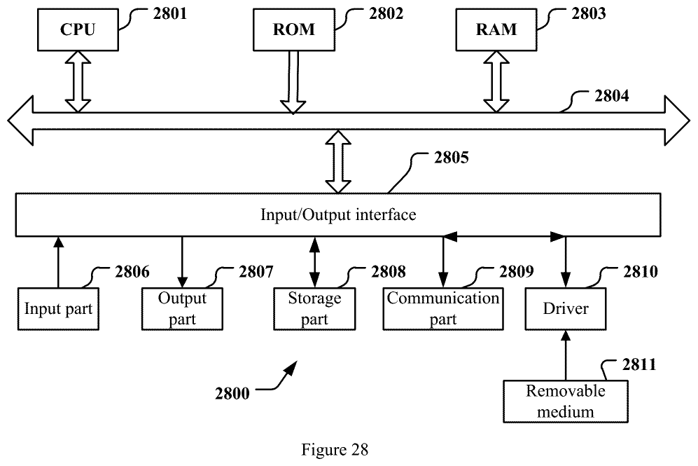

In a case of implementing the embodiments of the present disclosure in software or firmware, the program consisting of the software is mounted to a computer with a dedicated hardware structure (such as a general-purpose personal computer 2800 as shown in FIG. 28) from the storage medium or network. The computer, when mounted with various programs, performs various functions.

In FIG. 28, a central processing unit (CPU) 2801 executes various processing according to a program stored in a read-only memory (ROM) 2802 or a program loaded from a storage part 2808 to a random-access memory (RAM) 2803. In the RAM 2803, data required for the CPU 2801 to perform various processes or the like is also stored as necessary. The CPU 2801, the ROM 2802 and the RAM 2803 are connected to each other via a bus 2804. An input/output interface 2805 is connected to the bus 2804.

The following components are connected to the input/output interface 2805: an input part 2806 (including a keyboard, a mouse, and the like), an output part 2807 (including a display, such as a cathode ray tube (CRT) and a liquid crystal display (LCD), a loudspeaker, and the like), a storage part 2808 (including a hard disk and the like), and a communication part 2809 (including a network interface card, such as a LAN card, and a modem). The communication part 2809 performs communication processing via a network, such as the Internet. A driver 2810 may be connected to the input/output interface 2805 as needed. A removable medium 2811, such as a magnetic disk, an optical disk, a magnetic optical disk, and a semiconductor memory, is mounted to the driver 2810 as required, so that a computer program read therefrom is mounted to the storage part 2808 as required.

In a case that the above processes are implemented by software, the program consisting of the software is mounted from a network, such as the Internet, or from a storage medium, such as the removable medium 2811.

Those skilled in the art should understood that, the storage medium is not limited to the removable medium 2811, as shown in FIG. 28, which stores a program and is distributed separately from the apparatus so as to provide the program for a user. Examples of the removable medium 2811 includes a magnetic disk (including a soft disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 2802, the hard disk contained in the storage part 2808, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Moreover, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a (n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.

Solution 1. An electronic apparatus for wireless communications, comprising:
processing circuitry, configured to:
set, in relative narrowband transmit power RNTP signaling to be sent to a neighboring electronic apparatus in proximity to the electronic apparatus, following indication information comprised in information corresponding to a resource block according to report information that is reported by user equipment within a service range of the electronic apparatus and that is based on channel quality between the user equipment and the electronic apparatus and channel quality between the user equipment and the neighboring electronic apparatus,
wherein the indication information is utilized to indicate a degree to which the user equipment scheduled by the electronic apparatus on the resource block is interfered by the neighboring electronic apparatus.

Solution 2. The electronic apparatus according to solution 1, wherein
the degree of interference is determined by using a ratio of channel quality corresponding to the electronic apparatus to channel quality corresponding to the neighboring electronic apparatus.

Solution 3. The electronic apparatus according to solution 2, wherein the processing circuitry is configured to:
calculate the ratio based on the channel quality corresponding to the electronic apparatus and the channel quality corresponding to the neighboring electronic apparatus comprised in the report information,
perform the determination based on a comparison of the ratio to a first predetermined threshold, and
set the indication information based on a result of the determination.

Solution 4. The electronic apparatus according to solution 2, wherein the processing circuitry is configured to:
perform the determination based on a comparison of a first predetermined threshold to the ratio calculated by the user equipment and comprised in the report information, and
set the indication information based on a result of the determination.

Solution 5. The electronic apparatus according to solution 2, wherein
the report information comprises initial information indicating the degree of interference, wherein the initial information is obtained by the user equipment based on a comparison of the ratio to a first predetermined threshold, and
the processing circuitry is configured to set the indication information based on the initial information.

Solution 6. The electronic apparatus according to any one of solutions 1 to 5, wherein
the processing circuitry is configured to set the indication information further based on beam information indicating whether the user equipment is within a range of a directional beam of the neighboring electronic apparatus.

Solution 7. The electronic apparatus according to any one of solutions 1 to 6, wherein the report information comprises a cell ID of a cell to which the electronic apparatus belongs and a cell ID of a cell to which the neighboring electronic apparatus belongs.

Solution 8. The electronic apparatus according to any one of solutions 1 to 7, wherein the neighboring electronic apparatus is capable of communicating with the electronic apparatus through an X2 interface.

Solution 9. The electronic apparatus according to any one of solutions 1 to 8, wherein the channel quality comprises a reference signal received power or a signal to interference and noise ratio of a reference signal.

Solution 10. The electronic apparatus according to any one of solutions 1 to 9, wherein
the electronic apparatus and the neighboring electronic apparatus are baseband processing units BBUs in a distributed multiple-input multiple-output D-MIMO system.

Solution 11. An electronic apparatus for wireless communications, comprising:
processing circuitry configured to perform scheduling based on relative narrowband transmit power RNTP signaling received from a neighboring electronic apparatus in proximity to the electronic apparatus,
wherein the neighboring electronic apparatus sets, in the RNTP signaling, following indication information comprised in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, wherein the indication information is utilized to indicate a degree to which the user equipment scheduled by the neighboring electronic apparatus on the resource block is interfered by the electronic apparatus.

Solution 12. The electronic apparatus according to solution 11, wherein
the degree of interference is determined by using a ratio of channel quality corresponding to the neighboring electronic apparatus to channel quality corresponding to the electronic apparatus.

Solution 13. The electronic apparatus according to solution 12, wherein the determination is performed based on a comparison of a first predetermined threshold to the ratio.

Solution 14. The electronic apparatus according to any one of solutions 11 to 13, wherein the information corresponding to the resource block further comprises power information indicating whether the neighboring electronic apparatus schedules the user equipment on the resource block at a transmit power higher than a second predetermined threshold.

Solution 15. The electronic apparatus according to solution 14, wherein
the processing circuitry is configured to schedule central user equipment in a cell to which the electronic apparatus belongs on the resource block at a transmit power higher than a third predetermined threshold, or schedule edge user equipment in the cell which is not interfered by the neighboring electronic apparatus on the resource block at a transmit power higher than the third predetermined threshold, in a case where the power information indicates that the neighboring electronic apparatus schedules the user equipment on the resource block at a transmit power higher than the second predetermined threshold and the indication information indicates a low degree of interference.

Solution 16. The electronic apparatus according to any one of solutions 11 to 15, wherein the indication information is further set by the neighboring electronic apparatus based on beam information indicating whether the user equipment scheduled by the neighboring electronic apparatus on the resource block is within a range of a directional beam of the electronic apparatus.

Solution 17. The electronic apparatus according to solution 16, wherein the processing circuitry is configured to:
avoid scheduling user equipment that is aligned or close to a direction of the directional beam, in a case where the beam information indicates that the user equipment scheduled by the neighboring electronic apparatus on the resource block is within the range of the directional beam of the electronic apparatus.

Solution 18. The electronic apparatus according to any one of solutions 11 to 17, wherein the report information comprises a cell ID of a cell to which the electronic apparatus belongs and a cell ID of a cell to which the neighboring electronic apparatus belongs.

Solution 19. The electronic apparatus according to any one of solutions 11 to 18, wherein the neighboring electronic apparatus is capable of communicating with the electronic apparatus through an X2 interface.

Solution 20. The electronic apparatus according to any one of solutions 11 to 19, wherein the channel quality comprises a reference signal received power or a signal to interference and noise ratio of a reference signal.

Solution 21. The electronic apparatus according to any one of solutions 11 to 20, wherein the electronic apparatus and the neighboring electronic apparatus are baseband processing units BBUs in a distributed multiple-input multiple-output D-MIMO system.

Solution 22. An electronic apparatus for wireless communications, comprising:
processing circuitry, configured to:
report, to a network-side apparatus that provides services for the electronic apparatus, report information that is based on channel quality between the electronic apparatus and the network-side apparatus and channel quality between the electronic apparatus and a neighboring network-side apparatus in proximity to the network-side apparatus, for the network-side apparatus to set following indication information comprised in information corresponding to a resource block in relative narrowband transmit power RNTP signaling to be sent to the neighboring network-side apparatus, wherein the indication information is utilized to indicate a degree to which the electronic apparatus scheduled by the network-side apparatus on the resource block is interfered by the neighboring network-side apparatus.

Solution 23. The electronic apparatus according to solution 22, wherein
the degree of interference is determined by using a ratio of channel quality corresponding to the network-side apparatus to channel quality corresponding to the neighboring network-side apparatus.

Solution 24. The electronic apparatus according to solution 23, wherein
the processing circuitry is configured to calculate the ratio and comprise the ratio in the report information, for the network-side apparatus to set the indication information based on the ratio.

Solution 25. The electronic apparatus according to solution 23, wherein
the processing circuitry is configured to obtain initial information indicating the degree of interference based on a comparison of the ratio to a first predetermined threshold, and comprise the initial information in the report information, for the network-side apparatus to set the indication information based on the initial information.

Solution 26. An electronic apparatus for wireless communications, comprising:
processing circuitry, configured to:
set following power information comprised in information corresponding to a resource block in relative narrowband transmit power RNTP signaling to be sent to a neighboring electronic apparatus in proximity to the electronic apparatus, wherein the power information is utilized to indicate, for each of a plurality of remote radio head RRHs in a cell to which the electronic apparatus belongs, whether the RRH schedules user equipment on the resource block at a transmit power higher than a fourth predetermined threshold.

Solution 27. The electronic apparatus according to solution 26, wherein
the user equipment is served by an RRH which is closest to the user equipment.

Solution 28. The electronic apparatus according to solution 26 or 27, wherein
the electronic apparatus and the neighboring electronic apparatus are baseband processing units BBUs in a distributed multiple-input multiple-output D-MIMO system.

Solution 29. An electronic apparatus for wireless communications, comprising:
processing circuitry configured to perform scheduling based on relative narrowband transmit power RNTP signaling received from a neighboring electronic apparatus in proximity to the electronic apparatus,
wherein the neighboring electronic apparatus sets following power information comprised in information corresponding to a resource block in the RNTP signaling, the power information is utilized to indicate, for each of a plurality of remote radio head RRHs in a cell to which the neighboring electronic apparatus belongs, whether the RRH schedules user equipment on the resource block at a transmit power higher than a fourth predetermined threshold, and
a cell to which the electronic apparatus belongs comprises a plurality of RRHs.

Solution 30. The electronic apparatus according to solution 29, wherein the processing circuitry is configured to ignore, during the scheduling, power information which is comprised in the RNTP signaling and corresponds to an RRH at a distance greater than a fifth predetermined threshold from an RRH that serves to-be-scheduled user equipment.

Solution 31. The electronic apparatus according to solution 30, wherein
the to-be-scheduled user equipment is served by an RRH which is closest to the to-be-scheduled user equipment.

Solution 32. The electronic apparatus according to any one of solutions 29 to 31, wherein
the electronic apparatus and the neighboring electronic apparatus are baseband processing units BBUs in a distributed multiple-input multiple-output D-MIMO system.

Solution 33. A method for wireless communications, comprising:
setting, in relative narrowband transmit power RNTP signaling to be sent to a neighboring electronic apparatus in proximity to an electronic apparatus, following indication information comprised in information corresponding to a resource block according to report information that is reported by user equipment within a service range of the electronic apparatus and that is based on channel quality between the user equipment and the electronic apparatus and channel quality between the user equipment and the neighboring electronic apparatus, wherein the indication information is utilized to indicate a degree to which the user equipment scheduled by the electronic apparatus on the resource block is interfered by the neighboring electronic apparatus.

Solution 34. A method for wireless communications, comprising:
performing scheduling based on relative narrowband transmit power RNTP signaling received from a neighboring electronic apparatus in proximity to an electronic apparatus,
wherein the neighboring electronic apparatus sets, in the RNTP signaling, following indication information comprised in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, wherein the indication information is utilized to indicate a degree to which the user equipment scheduled by the neighboring electronic apparatus on the resource block is interfered by the electronic apparatus.

Solution 35. A method for wireless communications, comprising:
reporting, to a network-side apparatus that provides services for an electronic apparatus, report information that is based on channel quality between the electronic apparatus and the network-side apparatus and channel quality between the electronic apparatus and a neighboring network-side apparatus in proximity to the network-side apparatus, for the network-side apparatus to set following indication information comprised in information corresponding to a resource block in relative narrowband transmit power RNTP signaling to be sent to the neighboring network-side apparatus, wherein the indication information is utilized to indicate a degree to which the electronic apparatus scheduled by the network-side apparatus on the resource block is interfered by the neighboring network-side apparatus.

Solution 36. A method for wireless communications, comprising:
setting following power information comprised in information corresponding to a resource block in relative narrowband transmit power RNTP signaling to be sent to a neighboring electronic apparatus in proximity to an electronic apparatus, wherein the power information is utilized to indicate, for each of a plurality of remote radio head RRHs in a cell to which the electronic apparatus belongs, whether the RRH schedules user equipment on the resource block at a transmit power higher than a fourth predetermined threshold.

Solution 37. A method for wireless communications, comprising:
performing scheduling based on relative narrowband transmit power RNTP signaling received from a neighboring electronic apparatus in proximity to an electronic apparatus,
wherein the neighboring electronic apparatus sets following power information comprised in information corresponding to a resource block in the RNTP signaling, the power information is utilized to indicate, for each of a plurality of remote radio head RRHs in a cell to which the neighboring electronic apparatus belongs, whether the RRH schedules user equipment on the resource block at a transmit power higher than a fourth predetermined 5 threshold, and
a cell to which the electronic apparatus belongs comprises a plurality of RRHs.

Solution 38. A computer-readable storage medium storing computer-executable instructions which, when executed, perform the method for wireless communications according to any one of solutions 33 to 37.

1. An electronic apparatus for wireless communications comprising:
at least one processor; and
at least one memory including computer program code, where the at least one memory and the computer program code are configured, with the at least one processor, to cause the electronic apparatus to at least:
set, in relative narrowband transmit power RNTP signaling to be sent to a neighboring electronic apparatus in proximity to the electronic apparatus, following indication information comprised in information corresponding to a resource block according to report information that is reported by user equipment within a service range of the electronic apparatus and that is based on channel quality between the user equipment and the electronic apparatus and channel quality between the user equipment and the neighboring electronic apparatus, wherein the indication information is utilized to indicate a degree to which the user equipment scheduled by the electronic apparatus on the resource block is interfered by the neighboring electronic apparatus.

2. The electronic apparatus according to claim 1, wherein
the degree of interference is determined by using a ratio of channel quality corresponding to the electronic apparatus to channel quality corresponding to the neighboring electronic apparatus.

3. The electronic apparatus according to claim 2, wherein the at least one memory and the computer program code are further configured, with the at least one processor, to cause the electronic apparatus to:
calculate the ratio based on the channel quality corresponding to the electronic apparatus and the channel quality corresponding to the neighboring electronic apparatus comprised in the report information,
perform the determination based on a comparison of the ratio to a first predetermined threshold, and
set the indication information based on a result of the determination.

4. The electronic apparatus according to claim 2, wherein the at least one memory and the computer program code are further configured, with the at least one processor, to cause the electronic apparatus to:
perform the determination based on a comparison of a first predetermined threshold to the ratio calculated by the user equipment and comprised in the report information, and
set the indication information based on a result of the determination.

5. The electronic apparatus according to claim 2, wherein
the report information comprises initial information indicating the degree of interference, wherein the initial information is obtained by the user equipment based on a comparison of the ratio to a first predetermined threshold, and
the at least one memory and the computer program code are further configured, with the at least one processor, to cause the electronic apparatus to set the indication information based on the initial information.

6. The electronic apparatus according to claim 1, wherein
the at least one memory and the computer program code are further configured, with the at least one processor, to cause the electronic apparatus to set the indication information further based on beam information indicating whether the user equipment is within a range of a directional beam of the neighboring electronic apparatus.

7. The electronic apparatus according to claim 1, wherein the report information comprises a cell ID of a cell to which the electronic apparatus belongs and a cell ID of a cell to which the neighboring electronic apparatus belongs.

8. The electronic apparatus according to claim 1, wherein the neighboring electronic apparatus is capable of communicating with the electronic apparatus through an X2 interface.

9. The electronic apparatus according to claim 1, wherein the channel quality comprises a reference signal received power or a signal to interference and noise ratio of a reference signal.

10. The electronic apparatus according to claim 1, wherein
the electronic apparatus and the neighboring electronic apparatus are baseband processing units BBUs in a distributed multiple-input multiple-output D-MIMO system.

11. An electronic apparatus for wireless communications comprising:
at least one processor; and
at least one memory including computer program code, where the at least one memory and the computer program code are configured, with the at least one processor, to cause the electronic apparatus to at least:
perform scheduling based on relative narrowband transmit power RNTP signaling received from a neighboring electronic apparatus in proximity to the electronic apparatus,
wherein the neighboring electronic apparatus sets, in the RNTP signaling, following indication information comprised in information corresponding to a resource block according to report information that is reported by user equipment within a service range of the neighboring electronic apparatus and that is based on channel quality between the user equipment and the neighboring electronic apparatus and channel quality between the user equipment and the electronic apparatus, wherein the indication information is utilized to indicate a degree to which the user equipment scheduled by the neighboring electronic apparatus on the resource block is interfered by the electronic apparatus.

12. The electronic apparatus according to claim 11, wherein
the degree of interference is determined by using a ratio of channel quality corresponding to the neighboring electronic apparatus to channel quality corresponding to the electronic apparatus.

13. The electronic apparatus according to claim 12, wherein the determination is performed based on a comparison of a first predetermined threshold to the ratio.

14. The electronic apparatus according to claim 11, wherein the information corresponding to the resource block further comprises power information indicating whether the neighboring electronic apparatus schedules the user equipment on the resource block at a transmit power higher than a second predetermined threshold.

15. The electronic apparatus according to claim 14, wherein
the at least one memory and the computer program code are further configured, with the at least one processor, to cause the electronic apparatus to schedule central user equipment in a cell to which the electronic apparatus belongs on the resource block at a transmit power higher than a third predetermined threshold, or schedule edge user equipment in the cell which is not interfered by the neighboring electronic apparatus on the resource block at a transmit power higher than the third predetermined threshold, in a case where the power information indicates that the neighboring electronic apparatus schedules the user equipment on the resource block at a transmit power higher than the second predetermined threshold and the indication information indicates a low degree of interference.

16. The electronic apparatus according to claim 11, wherein the indication information is further set by the neighboring electronic apparatus based on beam information indicating whether the user equipment scheduled by the neighboring electronic apparatus on the resource block is within a range of a directional beam of the electronic apparatus.

17. The electronic apparatus according to claim 16, wherein the at least one memory and the computer program code are further configured, with the at least one processor, to cause the electronic apparatus to:
avoid scheduling user equipment that is aligned or close to a direction of the directional beam, in a case where the beam information indicates that the user equipment scheduled by the neighboring electronic apparatus on the resource block is within the range of the directional beam of the electronic apparatus.

18.-25. (canceled)

26. An electronic apparatus for wireless communications comprising:
at least one processor; and
at least one memory including computer program code, where the at least one memory and the computer program code are configured, with the at least one processor, to cause the electronic apparatus to at least:
set following power information comprised in information corresponding to a resource block in relative narrowband transmit power RNTP signaling to be sent to a neighboring electronic apparatus in proximity to the electronic apparatus, wherein the power information is utilized to indicate, for each of a plurality of remote radio head RRHs in a cell to which the electronic apparatus belongs, whether the RRH schedules user equipment on the resource block at a transmit power higher than a fourth predetermined threshold.

27. The electronic apparatus according to claim 26, wherein
the user equipment is served by an RRH which is closest to the user equipment.

28. The electronic apparatus according to claim 26, wherein
the electronic apparatus and the neighboring electronic apparatus are baseband processing units BBU in a distributed multiple-input multiple-output D-MIMO system.

29.-38. (canceled)
